(19) United States
(12) Patent Application Publication
(10) Pub. No.: US 2020/0221394 A1
(43) Pub. Date: Jul. 9, 2020

(54) TERMINAL APPARATUS, BASE STATION APPARATUS, AND COMMUNICATION METHOD

(71) Applicant: Sharp Kabushiki Kaisha, Sakai City, Osaka (JP)

(72) Inventors: Tomoki YOSHIMURA, Sakai City (JP); Shouichi SUZUKI, Sakai City (JP); Wataru OHUCHI, Sakai City (JP); Liqing LIU, Sakai City (JP); Taewoo LEE, Sakai City (JP)

(21) Appl. No.: 16/647,551

(22) PCT Filed: Jul. 25, 2018
(86) PCT No.: PCT/JP2018/027983

§ 371 Date: Mar. 16, 2020

(30) Foreign Application Priority Data
Sep. 27, 2017 (JP) 2017-186511

(51) Int. Cl. H04W 52/32; H04W 72/04; H04W 52/14; H04B 1/713

(52) U.S. Cl. CPC H04W 52/325; H04B 1/713; H04W 52/146; H04W 72/0413

(57) ABSTRACT

An apparatus includes a receiver configured to receive first RRC signaling, a controller configured to determine transmit power of a PUCCH, and a transmitter configured to transmit uplink control information on the PUCCH. The first RRC signaling includes information indicating whether or not frequency hopping is applied to the PUCCH. The transmit power of the PUCCH is given based on at least a parameter Δₓ. The parameter Δₓ is given based on at least whether or not the frequency hopping is applied to the PUCCH.

### TECHNICAL FIELD

The present invention relates to a terminal apparatus, a base station apparatus, and a communication method.

### BACKGROUND ART

In the 3rd Generation Partnership Project (3GPP), a radio access method and a radio network for cellular mobile communications (hereinafter referred to as “Long Term Evolution (LTE)” or “Evolved Universal Terrestrial Radio Access (EUTRA)”) have been studied. In LTE, a base station apparatus is also referred to as an evolved NodeB (eNodeB), and a terminal apparatus is also referred to as a User Equipment (UE). LTE is a cellular communication system in which multiple areas are deployed in a cellular structure, with each of the multiple areas being covered by a base station apparatus. A single base station apparatus may manage multiple serving cells.

In the 3GPP, for proposal to International Mobile Telecommunication (IMT)-2020, which is a standard for next-generation mobile communication system developed by the International Telecommunications Union (ITU), a next-generation standard (New Radio (NR)) has been studied (NPL 1). NR has been requested to meet requirements assuming three scenarios: enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology,” RP-160671, NTT docomo, 3GPP TSG RAN Meeting #71, Goteborg, Sweden, 7th-10th March, 2016.

### SUMMARY OF INVENTION

### Technical Problem

The present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention is a terminal apparatus including: a receiver configured to receive first RRC signaling; a controller configured to determine transmit power of a PUCCH; and a transmitter configured to transmit uplink control information on the PUCCH, wherein the first RRC signaling includes information indicating whether or not frequency hopping is applied to the PUCCH, the transmit power of the PUCCH is given based on at least a parameter Δₓ, and the parameter Δₓ is given based on at least whether or not the frequency hopping is applied to the PUCCH.

(2) A second aspect of the present invention is a base station apparatus including: a transmitter configured to transmit first RRC signaling; and a receiver configured to receive uplink control information transmitted on a PUCCH, wherein the first RRC signaling includes information indicating whether or not frequency hopping is applied to the PUCCH, the transmit power of the PUCCH is given based on at least a parameter Δₓ, and the parameter Δₓ is given based on at least whether or not the frequency hopping is applied to the PUCCH.

(3) A third aspect of the present invention is a communication method used for a terminal apparatus, including the steps of: receiving first RRC signaling; determining transmit power of a PUCCH; and transmitting uplink control information on the PUCCH, wherein the first RRC signaling includes information indicating whether or not frequency hopping is applied to the PUCCH, the transmit power of the PUCCH is given based on at least a parameter Δₓ, and the parameter Δₓ is given based on at least whether or not the frequency hopping is applied to the PUCCH.

(4) A fourth aspect of the present invention is a communication method used for a base station apparatus, including the steps of: transmitting first RRC signaling; and receiving uplink control information transmitted on a PUCCH, wherein the first RRC signaling includes information indicating whether or not frequency hopping is applied to the PUCCH, the transmit power of the PUCCH is given based on at least a parameter Δₓ, and the parameter Δₓ is given based on at least whether or not the frequency hopping is applied to the PUCCH.

### Advantageous Effects of Invention

According to the present invention, the terminal apparatus can efficiently perform communication. The base station apparatus can efficiently perform communication.

### BRIEF DESCRIPTION OF DRAWINGS

FIG. 1 is a conceptual diagram of a radio communication system according to one aspect of the present embodiment.

FIG. 2 is an example illustrating a relationship between N^{slot}_{symb}, a subcarrier spacing configuration μ, a slot configuration, and a CP configuration according to one aspect of the present embodiment.

FIG. 3 is a schematic diagram illustrating an example of a resource grid of a subframe according to one aspect of the present embodiment.

FIG. 4 is a diagram illustrating a configuration example of a first PUCCH format according to one aspect of the present embodiment.

FIG. 5 is a diagram illustrating a configuration example of a second PUCCH format according to one aspect of the present embodiment.

FIG. 6 is a diagram illustrating a mapping example of a PUCCH and a DMRS associated with the PUCCH for a slot at the latter half of a subframe (or an odd-numbered slot), in the second PUCCH format to which frequency hopping is applied according to one aspect of the present embodiment.

FIG. 7 is a diagram illustrating a configuration example of a third PUCCH format according to one aspect of the present embodiment.

FIG. 8 is a diagram illustrating a configuration example of a fourth PUCCH format according to one aspect of the present embodiment.

FIG. 9 is a diagram illustrating a configuration example of a fifth PUCCH format in a case that the number of OFDM symbols to which the PUCCH is mapped is 1 according to one aspect of the present embodiment.

FIG. 10 is a diagram illustrating a configuration example of a sixth PUCCH format in a case that the number of OFDM symbols to which the PUCCH is mapped is 1 according to one aspect of the present embodiment.

FIG. 11 is a diagram illustrating a configuration example of a seventh PUCCH format in a case that frequency hopping is not applied according to one aspect of the present embodiment.

FIG. 12 is a diagram illustrating a configuration example of the seventh PUCCH format in a case that frequency hopping is applied according to one aspect of the present embodiment.

FIG. 13 is a diagram illustrating a configuration example of the seventh PUCCH format in a case that frequency hopping is applied according to one aspect of the present embodiment.

FIG. 14 is a diagram illustrating a configuration example of the seventh PUCCH format in a case that frequency hopping is applied according to one aspect of the present embodiment.

FIG. 15 is a diagram illustrating a configuration example of a parameter Δₓ according to one aspect of the present embodiment.

FIG. 16 is a diagram illustrating a configuration example of the parameter Δₓ according to one aspect of the present embodiment.

FIG. 17 is a diagram illustrating a configuration example of the parameter Δₓ according to one aspect of the present embodiment.

FIG. 18 is a schematic block diagram illustrating a configuration of a terminal apparatus 1 according to one aspect of the present embodiment.

FIG. 19 is a schematic block diagram illustrating a configuration of a base station apparatus 3 according to one aspect of the present embodiment.

### DESCRIPTION OF EMBODIMENTS

Embodiments of the present invention will be described below.

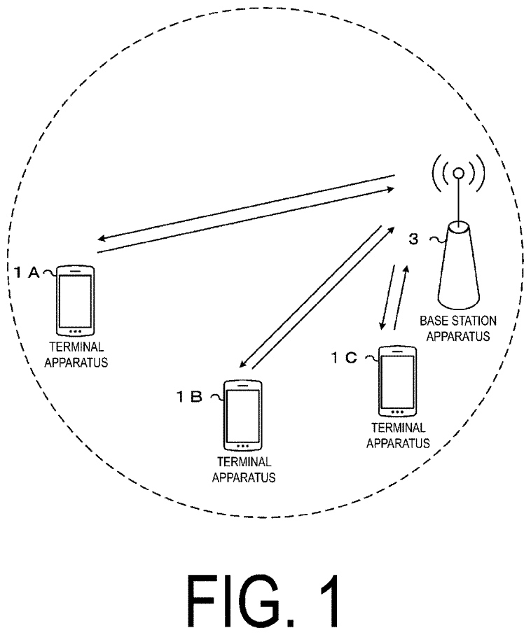

FIG. 1 is a conceptual diagram of a radio communication system according to one aspect of the present embodiment. In FIG. 1, a radio communication system includes terminal apparatuses 1A to 1C and a base station apparatus 3. Hereinafter, the terminal apparatuses 1A to 1C are also referred to as a terminal apparatus 1.

A frame configuration will be described below.

In the radio communication system according to one aspect of the present embodiment, at least Orthogonal Frequency Division Multiplex (OFDM) is used. An OFDM symbol, being one of the time domain units, includes at least one or more subcarriers, and is converted into a time-continuous signal (time-continulous signal) through baseband signal generation. In the radio communication system according to one aspect of the present embodiment, OFDM and Discrete Fourier Transform-spread OFDM (DFT-s-OFDM) may be used. The time domain unit is referred to as an OFDM symbol in either case that OFDM or DFT-s-OFDM is used in the radio communication system according to one aspect of the present embodiment.

A SubCarrier Spacing (SCS) may be given by the equation: subcarrier spacing Δf=2μ·15 kHz. μ is a subcarrier spacing configuration. For example, μ may be any of values 0 to 5. For a BandWidth Part (BWP), the subcarrier spacing configuration μ may be given by a higher layer parameter (subcarrier spacing configuration μ). The subcarrier spacing configuration μ may be a value defined in advance.

In the radio communication system according to one aspect of the present embodiment, a time unit Tₛ is used for representing a time domain length. The time unit Tₛ is given by the equation: Tₛ=1/(Δfₘₐₓ·N_{f}). Δfₘₐₓ may be a maximum value of the subcarrier spacing supported in the radio communication system according to one aspect of the present embodiment. Δfₘₐₓ may be Δfₘₐₓ=480 kHz. The time unit Tₛ is also referred to as Tₛ. A constant κ is κ=Δfₘₐₓ·N_{f}/(Δf_{ref}N_{f,ref})=64. Δf_{ref} is 15 kHz, and N_{f, ref} is 2048.

The constant κ may be a value indicating a relationship between a reference subcarrier spacing and Tₛ. The constant κ may be used for a subframe length. Based on at least the constant κ, the number of slots included in a subframe may be given. Δf_{ref} is a reference subcarrier spacing, and N_{f, ref} is a value corresponding to the reference subcarrier spacing.

Downlink transmission and/or uplink transmission is configured by a frame having a length of 10 ms. The frame includes 10 subframes. The subframe length is 1 ms. The frame length may be a value independent of the subcarrier spacing Δf. In other words, a frame configuration may be given regardless of μ. The subframe length may be a value independent of the subcarrier spacing Δf. In other words, a subframe configuration may be given regardless of μ. The subframe length may be given based on at least the equations: Δf_{ref}=15 kHz and N_{f, ref}=2048.

For the subcarrier spacing configuration μ (subcarrier spacing configuration), the number and the index of the slots included in the subframe may be given. For example, a first slot number n^{μ}ₛ may be given in the ascending order within a range from 0 to N^{subframe,μ}ₛₗₒₜ within the subframe. For the subcarrier spacing configuration μ, the number and the index of the slots included in the frame may be given. For example, a second slot number n^{μ}_{s, f} may be given in the ascending order within a range from 0 to N^{frame, μ}ₛₗₒₜ within the frame. N^{slot}_{symb} continuous OFDM symbols may be included in one slot. N^{slot}_{symb} may be given based on at least a part or all of a slot configuration and a Cyclic Prefix (CP) configuration. The slot configuration may be given by a higher layer parameter slot_configuration. The CP configuration may be given based on at least a higher layer parameter. The slot configuration may be a value defined in advance. For example, in a case that the subcarrier spacing configuration μ is 0, the slot configuration may be 1.

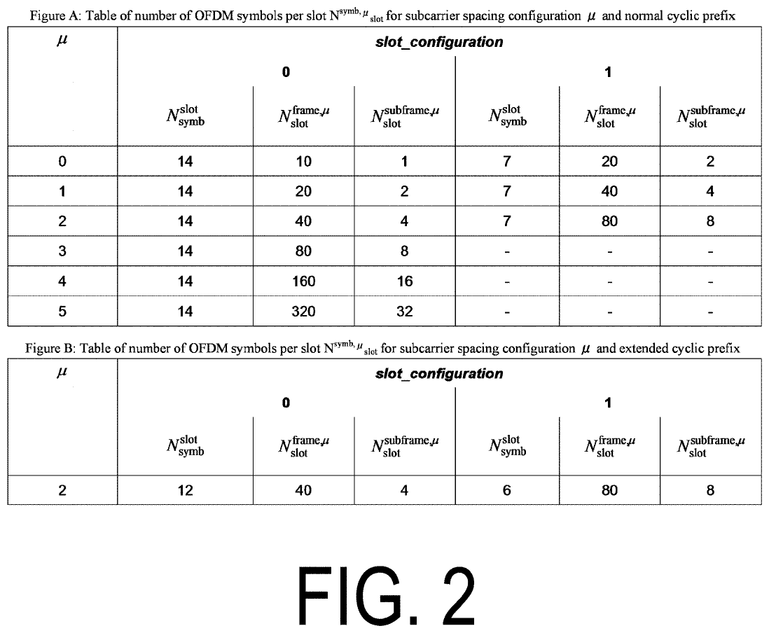

FIG. 2 is an example illustrating a relationship between N^{slot}_{symb}, the subcarrier spacing configuration μ, the slot configuration, and the CP configuration according to one aspect of the present embodiment. In FIG. 2A, in a case that the slot configuration is 0 and the CP configuration is a normal cyclic prefix (normal CP), N^{slot}_{symb}=14, N^{frame,μ}ₛₗₒₜ=40, and N^{subframe,μ}ₛₗₒₜ=4. In FIG. 2B, in a case that the slot configuration is 0 and the CP configuration is an extended cyclic prefix (extended CP), N^{slot}_{symb}=12, N^{frame,μ}ₛₗₒₜ=40, and N^{subframe,μ}ₛₗₒₜ=4. The value of N^{slot}_{symb} in slot configuration 0 may correspond to twice the value of N^{slot}_{symb} in slot configuration 1.

In LTE, the subcarrier spacing configuration μ may be 0, and the slot configuration may be 1. In other words, in LTE, the subcarrier spacing may be 15 kHz, the subframe may include two slots, and each of the slots may include seven OFDM symbols. In NR, slot configuration 1 may be at least supported.

Physical resources will be described below.

An antenna port is defined based on that a channel on which symbols are transmitted in one antenna port can be estimated based on a channel on which other symbols are transmitted in the same antenna port. In a case that large scale property of a channel on which symbols are transmitted in one antenna port can be estimated based on a channel on which symbols are transmitted in another antenna port, the two antenna ports are referred to as being “Quasi Co-Located (QCL)”. The large scale property may be long distance property of a channel. The large scale property may include at least a part or all of delay spread, doppler spread, Doppler shift, an average gain, average delay, and beam parameters (spatial Rx parameters). A case that a first antenna port and a second antenna port are quasi co-located (QCL) with respect to the beam parameters may be equivalent to a case that a receive beam that a reception side assumes for the first antenna port and a receive beam that the reception side assumes for the second antenna port are the same. A case that the first antenna port and the second antenna port are quasi co-located (QCL) with respect to the beam parameters may be equivalent to a case that a transmit beam that a reception side assumes for the first antenna port and a transmit beam that the reception side assumes for the second antenna port are the same. In a case that the large scale property of a channel on which symbols are transmitted in one antenna port can be estimated based on a channel on which symbols are transmitted in another antenna port, the terminal apparatus 1 may assume that the two antenna ports are quasi co-located (QCL). A case that two antenna ports are quasi co-located (QCL) may be equivalent to a case that two antenna ports are assumed to be quasi co-located (QCL).

For each of the subcarrier spacing configuration μ and a set of carriers, a resource grid including N^{μ}_{RB, x}N^{RB}_{sc} subcarriers and N^{(μ)}_{symb}N^{subframe,μ}_{symb} OFDM symbols is given. N^{μ}_{RB, x} may indicate the number of resource blocks given for the subcarrier spacing configuration μ for carrier x. Carrier x indicates either a downlink carrier or an uplink carrier. In other words, x is either a “DL” or a “UL”. N^{μ}_{RB} is an expression encompassing N^{μ}_{RB, DL} and N^{μ}_{RB, UL}. N^{RB}_{sc} may indicate the number of subcarriers included in one resource block. One resource grid may be given for each antenna port p, and/or for each subcarrier spacing configuration μ, and/or for each transmission direction (Transmissin direction) configuration. The transmission direction includes at least a DownLink (DL) and an UpLink (UL). A set of parameters including at least a part or all of the antenna port p, the subcarrier spacing configuration u, and the transmission direction configuration is hereinafter also referred to as a first radio parameter set. In other words, one resource grid may be given for each first radio parameter set.

Each element of the resource grid given for each first radio parameter set is referred to as a resource element. The resource element is identified by a frequency domain index k and a time domain index l. The resource element identified by the frequency domain index k and the time domain index l is also referred to as a resource element (k, l). The frequency domain index k indicates any value from 0 to N^{μ}_{RB}N^{RB}_{sc}−1. N^{μ}_{RB} may be the number of resource blocks given for the subcarrier spacing configuration μ. N^{RB}_{sc} is the number of subcarriers included in the resource block, and N^{RB}_{sc}=12. The frequency domain index k may correspond to a subcarrier index. The time domain index l may correspond to an OFDM symbol index.

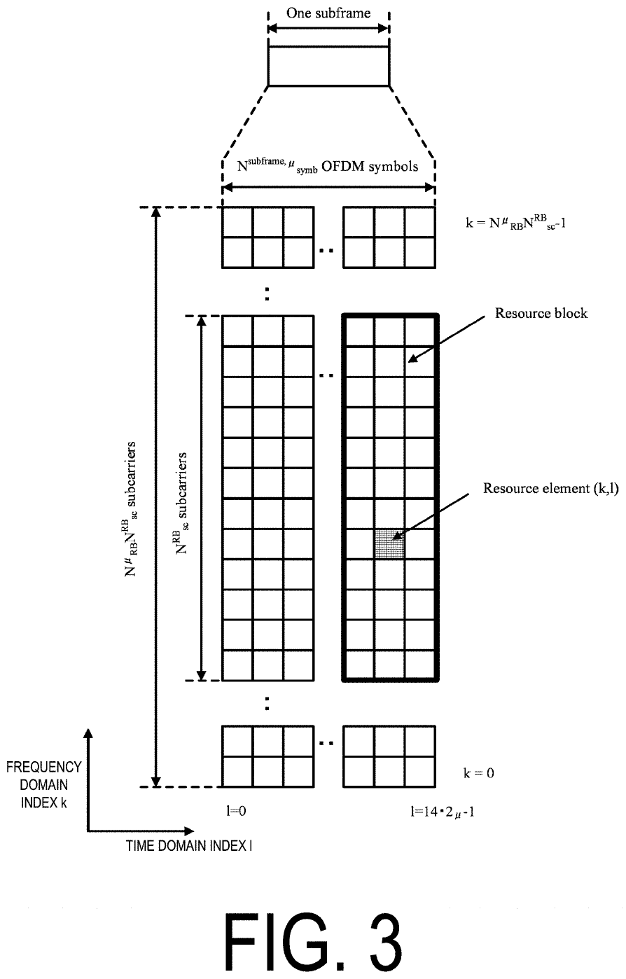

FIG. 3 is a schematic diagram illustrating an example of the resource grid of the subframe according to one aspect of the present embodiment. In the resource grid of FIG. 3, the horizontal axis represents the time domain index l and the vertical axis represents the frequency domain index k. In one subframe, the frequency domain of the resource grid may include N^{μ}_{RB}N^{RB}_{sc} subcarriers, and the time domain of the resource grid may include 14·2μ−1 OFDM symbols. The resource block includes N^{RB}_{sc} subcarriers. The time domain of the resource block may correspond to one OFDM symbol. The time domain of the resource block may correspond to one or more slots. The time domain of the resource block may correspond to one subframe.

The terminal apparatus may receive an indication to perform transmission and/or reception by using only a resource grid subset. The resource grid subset is also referred to as a BWP, and the BWP may be given by a higher layer parameter. In other words, the terminal apparatus need not receive an indication to perform transmission and/or reception by using the whole resource grid set. In other words, the terminal apparatus may receive an indication to perform transmission and/or reception by using a part of the resources in the resource grid.

The higher layer parameter is a parameter included in higher layer signaling. The higher layer signaling may be Radio Resource Control (RRC) signaling, or may be a Media Acess Control Control Element (MAC CE). Here, the higher layer signaling may be RRC layer signaling, or may be MAC layer signaling.

Physical channels and physical signals according to various aspects of the present embodiment will be described below.

An uplink physical channel may correspond to a set of resource elements for carrying information generated in the higher layer. The uplink physical channel is a physical channel used in the uplink. In the radio communication system according to one aspect of the present embodiment, at least a part or all of the following uplink physical channels are used.
Physical Uplink Control CHannel (PUCCH)
Physical Uplink Shared CHannel (PUSCH)
Physical Random Access CHannel (PRACH)

The PUCCH may be used for transmitting Uplink Control Information (UCI). The uplink control information includes a part or all of Channel State Information (CSI) of a downlink physical channel, a Scheduling Request (SR), and a Hybrid Automatic Repeat request ACKnowledgement (HARQ-ACK) for downlink data (a Transport block (TB), a Medium Access Control Protocol Data Unit (MAC PDU), a Downlink-Shared Channel (DL-SCH), a Physical Downlink Shared Channel (PDSCH)). The HARQ-ACK may indicate an acknowledgement (ACK) or a negative-acknowledgement (NACK) for the downlink data.

The HARQ-ACK may indicate an ACK or a NACK corresponding to each of one or more Code Block Groups (CBGs) included in the downlink data. The HARQ-ACK is also referred to as a HARQ feedback, HARQ information, HARQ control information, and an ACK/NACK.

The scheduling request may be used at least for requesting PUSCH (Uplink-Shared Channel (UL-SCH)) resources for initial transmission.

The Channel State Information (CSI) includes at least a Channel Quality Indicator (CQI) and a Rank Indicator (RI). The channel quality indicator may include a Precoder Matrix Indicator (PMI). The CQI is an indicator associated with channel quality (propagation strength), and the PMI is an indicator for indicating a precoder. The RI is an indicator for indicating a transmission rank (or the number of transmission layers).

The PUSCH is used to transmit uplink data (TB, MAC PDU, UL-SCH, PUSCH). The PUSCH may be used to transmit HARQ-ACK and/or channel state information together with the uplink data. Furthermore, the PUSCH may be used to transmit only the channel state information or to transmit only the HARQ-ACK and the channel state information. The PUSCH is used to transmit random access message 3.

The PRACH is used to transmit a random access preamble (random access message 1). The PRACH is used for indicating initial connection establishment procedure, handover procedure, connection re-establishment procedure, synchronization (timing adjustment) for uplink data transmission, and a request for a PUSCH (UL-SCH) resource. The random access preamble may be used to notify the base station apparatus 3 of an index (random access preamble index) given by the higher layer of the terminal apparatus 1.

In FIG. 1, the following uplink physical signals are used for the uplink radio communication. The uplink physical signal need not be used for transmitting information output from the higher layer, but is used by the physical layer.
UpLink Demodulation Reference Signal (UL DMRS)
Sounding Reference Signal (SRS)

The UL DMRS is associated with transmission of the PUSCH and/or the PUCCH. The UL DMRS is multiplexed on the PUSCH or the PUCCH. The base station apparatus 3 may use the UL DMRS in order to perform channel compensation of the PUSCH or the PUCCH. Simultaneous transmission of the PUSCH and the UL DMRS associated with the PUSCH is hereinafter simply referred to as transmission of the PUSCH. Simultaneous transmission of the PUCCH and the UL DMRS associated with the PUCCH is hereinafter simply referred to as transmission of the PUCCH. The UL DMRS associated with the PUSCH is also referred to as a PUSCH UL DMRS. The UL DMRS associated with the PUCCH is also referred to as a PUCCH UL DMRS.

The SRS need not be associated with transmission of the PUSCH or the PUCCH. The base station apparatus 3 may use the SRS to measure the channel state. The SRS may be transmitted at the end of the subframe in an uplink slot, or at an OFDM symbol preceding the end by a prescribed number of OFDM symbols.

In FIG. 1, the following downlink physical channels are used for downlink radio communication from the base station apparatus 3 to the terminal apparatus 1. The downlink physical channels are used by the physical layer for transmission of information output from the higher layer.
Physical Broadcast Channel (PBCH)
Physical Downlink Control Channel (PDCCH)
Physical Downlink Shared Channel (PDSCH)

The PBCH is used to transmit a Master Information Block (a MIB, a BCH, a Broadcast Channel). The PBCH may be transmitted based on a prescribed transmission interval. For example, the PBCH may be transmitted at intervals of 80 ms. Contents of information included in the PBCH may be updated every 80 ms. The PBCH may include 288 subcarriers. The PBCH may include 2, 3, or 4 OFDM symbols. The MIB may include information relating to an identifier (index) of a synchronization signal. The MIB may include information for indicating at least a part of: the number of the slot in which PBCH is transmitted, the number of the subframe in which PBCH is transmitted, and the number of the radio frame in which PBCH is transmitted.

The PDCCH is used to transmit Downlink Control Information (DCI). The downlink control information is also referred to as a DCI format. The downlink control information may include at least either a downlink grant or an uplink grant. The downlink grant is also referred to as a downlink assignment or a downlink allocation.

A single downlink grant is used for at least scheduling of a single PDSCH in a single serving cell. The downlink grant is used at least for the scheduling of the PDSCH in the same slot as the slot in which the downlink grant is transmitted.

A single uplink grant is used at least for scheduling of a single PUSCH in a single serving cell.

One physical channel may be mapped to one serving cell. One physical channel need not be mapped to multiple serving cells.

To search for the PDCCH, one or more control resource sets may be configured for the terminal apparatus 1. The terminal apparatus 1 attempts to receive the PDCCH in the configured control resource set(s). The control resource set may be defined in advance.

The control resource set may indicate a time frequency domain in which one or more PDCCHs can be mapped. The control resource set may be a region in which the terminal apparatus 1 attempts to receive the PDCCH.

The frequency domain of the control resource set may be identical to the system bandwidth of the serving cell. The frequency domain of the control resource set may be provided based on at least the system bandwidth of the serving cell. The frequency domain of the control resource set may be provided based on at least higher layer signaling and/or downlink control information.

The time domain of the control resource set may be provided based on at least a higher layer parameter.

The PDSCH is used to transmit downlink data (DL-SCH, PDSCH). The PDSCH is used at least for transmitting random access message 2 (random access response). The PDSCH is used at least for transmitting system information including parameters used for initial access.

The PDSCH is given based on at least a part or all of Scrambling, Modulation, layer mapping, precoding, and Mapping to physical resources. The terminal apparatus 1 may assume that the PDSCH is given based on at least a part or all of scrambling, modulation, layer mapping, precoding, and mapping to physical resources.

In FIG. 1, the following downlink physical signals are used for the downlink radio communication. The downlink physical signal need not be used for transmitting the information output from the higher layer, but is used by the physical layer.
Synchronization signal (SS)
DownLink DeModulation Reference Signal (DL DMRS)
Channel State Information-Reference Signal (CSI-RS)

The synchronization signal is used for the terminal apparatus 1 to establish synchronization in the frequency domain and/or the time domain in the downlink. The synchronization signal includes a Primary Synchronization Signal (PSS) and a Secondary Synchronization Signal (SSS).

An SS block includes at least a part or all of the PSS, the SSS, and the PBCH. The antenna port for each of a part or all of the PSS, the SSS, and the PBCH included in the SS block may be the same. A part or all of the PSS, the SSS, and the PBCH included in the SS block may be mapped to continuous OFDM symbols. The CP configuration of each of a part or all of the PSS, the SSS, and the PBCH included in the SS block may be the same. The subcarrier spacing configuration μ of each of a part or all of the PSS, the SSS, and the PBCH included in the SS block may be the same. The SS block is also referred to as an SS/PBCH block.

The DL DMRS is associated with transmission of the PBCH, the PDCCH, and/or the PDSCH. The DL DMRS is multiplexed on the PBCH, the PDCCH, or the PDSCH. In order to perform channel compensation of the PBCH, the PDCCH, or the PDSCH, the terminal apparatus 1 may use the DL DMRS that corresponds to the PBCH, the PDCCH, or the PDSCH. Transmission of the PBCH and the DL DMRS associated with the PBCH together is hereinafter shortly referred to as transmission of the PBCH. Transmission of the PDCCH and the DL DMRS associated with the PDCCH together is hereinafter simply referred to as transmission of the PDCCH. Transmission of the PDSCH and the DL DMRS associated with the PDSCH together is hereinafter simply referred to as transmission of the PDSCH. The DL DMRS associated with the PBCH is also referred to as a PBCH DL DMRS. The DL DMRS associated with the PDSCH is also referred to as a PDSCH DL DMRS. The DL DMRS associated with the PDCCH is also referred to as a DL DMRS associated with the PDCCH.

The DL DMRS may be a reference signal configured for each individual terminal apparatus 1. A DL DMRS sequence may be given based on at least a parameter configured for each individual terminal apparatus 1. The DL DMRS sequence may be given based on at least a UE-specific value (for example, a C-RNTI or the like). The DL DMRS may be transmitted for each individual PDCCH and/or PDSCH. In contrast, the Shared RS may be a reference signal configured to be shared by multiple terminal apparatuses 1. A Shared RS sequence may be given regardless of a parameter configured for each individual terminal apparatus 1. For example, the Shared RS sequence may be given based on at least some of the slot number, the mini-slot number, or a cell ID (identity). The Shared RS may be a reference signal to be transmitted, regardless of whether the PDCCH and/or the PDSCH is transmitted.

The CSI-RS may be a signal used at least for calculating channel state information. CSI-RS patterns assumed by the terminal apparatus may be given by at least a higher layer parameter.

Each of the downlink physical channel and the downlink physical signal is also referred to as a downlink signal. Each of the uplink physical channel and the uplink physical signal is also referred to as an uplink signal. The downlink signal and the uplink signal are collectively also referred to as a signal. The downlink physical channel and the uplink physical channel are collectively referred to as a physical channel. The downlink physical signal and the uplink physical signal are collectively referred to as a physical signal.

The BCH, the UL-SCH, and the DL-SCH are transport channels. The channel used in the Medium Access Control (MAC) layer is referred to as a transport channel. The unit of transport channels used in the MAC layer is also referred to as a transport block (TB) or a MAC PDU. A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and modulation processing is performed for each codeword.

A first PUCCH format to an eighth PUCCH format will be described below.

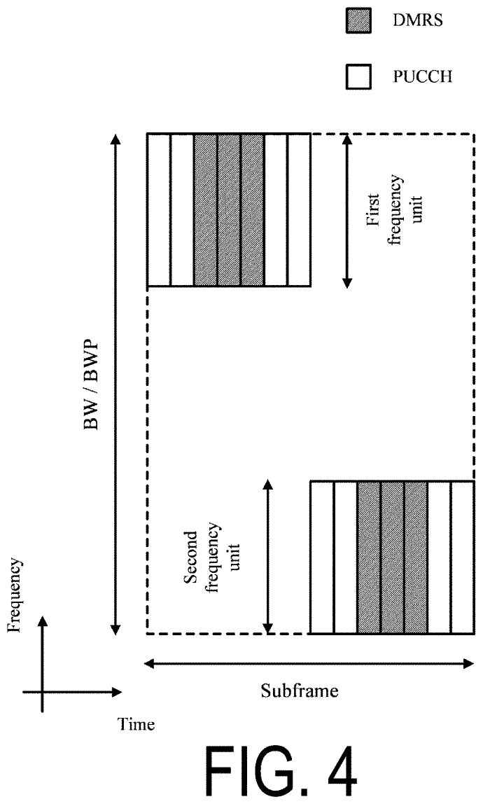

The first PUCCH format may be used to transmit the HARQ-ACK and/or the SR of up to 2 bits. FIG. 4 is a diagram illustrating a configuration example of the first PUCCH format according to one aspect of the present embodiment. In FIG. 4, the vertical axis represents a Frequency bandwidth. The frequency bandwidth may include a BandWidth (BW). The frequency bandwidth may include a BandWidth Part (BWP). The BW may be a frequency bandwidth given based on at least treaties and laws (such as Radio Act), as well as other regulations. The BW may be a frequency bandwidth defined in advance. The BWP may be a frequency bandwidth given based on at least a higher layer parameter and/or DCI. In FIG. 4, the horizontal axis represents a scheduling unit in the time domain. The scheduling unit may include a subframe. The scheduling unit may include a slot. The scheduling unit may be given based on at least the subcarrier spacing configuration μ and/or the slot configuration. The scheduling unit may indicate a Transmission Time Interval (TTI). In FIG. 4, the scheduling unit is a subframe, subcarrier spacing configuration μ=0, and the slot configuration is 1. In other words, in FIG. 4, the number of slots included in the subframe is 2, and the number OFDM symbols included in each of the slots is 7.

In FIG. 4, the PUCCH is mapped to eight OFDM symbols, and the DMRS associated with the PUCCH is mapped to six OFDM symbols. In FIG. 4, four OFDM symbols to which the PUCCH is mapped and three OFDM symbols to which the DMRS is mapped are included in each of a First frequency unit and a Second frequency unit. A scheme in which the PUCCH and/or the DMRS associated with the PUCCH is at least mapped to the first frequency unit and the second frequency unit as described above is also referred to as frequency hopping. In frequency hopping, a hopping number Nₕₒₚ may be given by a value calculated by subtracting 1 from the number of frequency units to which the PUCCH and/or the DMRS associated with the PUCCH is mapped. In other words, in FIG. 4, hopping number Nₕₒₚ=1. A case that frequency hopping is not applied may indicate hopping number Nₕₒₚ=0.

In frequency hopping, first OFDM symbols to which the PUCCH included in the first frequency unit is mapped (or a first OFDM symbol group including the first OFDM symbols to which the PUCCH is mapped) and second OFDM symbols to which the PUCCH included in the second frequency unit is mapped (or a second OFDM symbol group including the second OFDM symbols to which the PUCCH is mapped) may be different from each other.

The number N_{PUCCH, 1} of OFDM symbols to which the PUCCH included in the first frequency unit is mapped is defined as the number of OFDM symbols included in the first frequency unit out of the number of OFDM symbols to which the PUCCH is mapped. The number N_{PUCCH, 2} of OFDM symbols to which the PUCCH included in the second frequency unit is mapped is defined as the number of OFDM symbols included in the second frequency unit out of the number of OFDM symbols to which the PUCCH is mapped.

The number N_{DMRS, 1} of OFDM symbols to which the DMRS included in the first frequency unit is mapped is defined as the number of OFDM symbols included in the first frequency unit out of the number of OFDM symbols to which the DMRS is mapped. The number N_{DMRS, 2} of OFDM symbols to which the DMRS included in the second frequency unit is mapped is defined as the number of OFDM symbols included in the second frequency unit out of the number of OFDM symbols to which the DMRS is mapped. The DMRS may be a DMRS associated with the PUCCH.

The number N_{PUCCH_DMRS, 1} of OFDM symbols to which the PUCCH and the DMRS included in the first frequency unit are mapped is defined as the number of OFDM symbols included in the first frequency unit out of the number of OFDM symbols to which the PUCCH and the DMRS are mapped. The number N_{PUCCH_DMRS, 2} of OFDM symbols to which the PUCCH and the DMRS included in the second frequency unit are mapped is defined as the number of OFDM symbols included in the second frequency unit out of the number of OFDM symbols to which the PUCCH and the DMRS are mapped. The DMRS may be a DMRS associated with the PUCCH.

In FIG. 4, the number N_{PUCCH, 1} of OFDM symbols to which the PUCCH included in the first frequency unit is mapped is 4. The number N_{PUCCH, 2} of OFDM symbols to which the PUCCH included in the second frequency unit is mapped is 4. The number N_{DMRS, 1} of OFDM symbols to which the DMRS included in the first frequency unit is mapped is 3. The number N_{DMRS, 2} of OFDM symbols to which the DMRS included in the second frequency unit is mapped is 3. The number N_{PUCCH_DMRS, 1} of OFDM symbols to which the PUCCH and the DMRS included in the first frequency unit are mapped is 7. The number N_{PUCCH_DMRS, 2} of OFDM symbols to which the PUCCH and the DMRS included in the second frequency unit are mapped is 7.

The PUCCH and the DMRS associated with the PUCCH are also collectively referred to as the PUCCH.

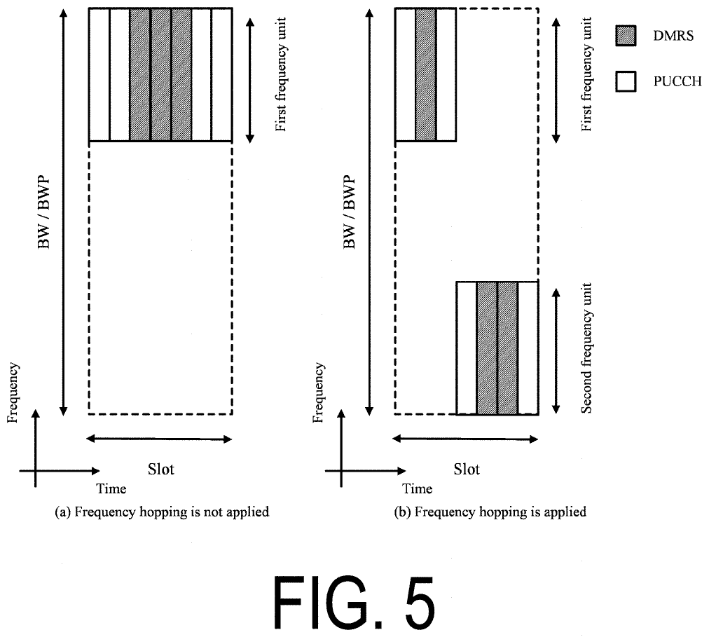

FIG. 5 is a diagram illustrating a configuration example of the second PUCCH format according to one aspect of the present embodiment. The second PUCCH format may be used to transmit the HARQ-ACK and/or the SR of up to 2 bits. In FIG. 5, the scheduling unit is one slot. The second PUCCH format may include four OFDM symbols to which the PUCCH is mapped and three OFDM symbols to which the PUCCH associated with the PUCCH is mapped.

FIG. 5(a) illustrates a configuration example of the second PUCCH format in a case that frequency hopping is not applied. In the second PUCCH format to which frequency hopping is not applied, all of the OFDM symbols to which the PUCCH is mapped may be mapped to the first frequency unit. In the second PUCCH format to which frequency hopping is not applied, the OFDM symbols to which the PUCCH is mapped may be the 1st, 2nd, 6th, and 7th OFDM symbols within the slot. In the second PUCCH format to which frequency hopping is not applied, the OFDM symbols to which the DMRS associated with the PUCCH is mapped may be the 3rd, 4th, and 5th OFDM symbols within the slot.

In FIG. 5(a), the number N_{PUCCH, 1} of OFDM symbols to which the PUCCH included in the first frequency unit is mapped is 4. The number N_{PUCCH, 2} of OFDM symbols to which the PUCCH included in the second frequency unit is mapped is 0. The number N_{DMRS, 1} of OFDM symbols to which the DMRS included in the first frequency unit is mapped is 3. The number N_{DMRS, 2} of OFDM symbols to which the DMRS included in the second frequency unit is mapped is 0. The number N_{PUCCH_DMRS, 1} of OFDM symbols to which the PUCCH and the DMRS included in the first frequency unit are mapped is 7. The number N_{PUCCH_DMRS, 2} of OFDM symbols to which the PUCCH and the DMRS included in the second frequency unit are mapped is 0.

FIG. 5(b) illustrates a configuration example of the second PUCCH format in a case that frequency hopping is applied. In the second PUCCH format to which frequency hopping is applied, at least a part of the OFDM symbols to which the PUCCH is mapped may be mapped to the second frequency unit. In the second PUCCH format in the case that frequency hopping is applied, the total number of OFDM symbols to which the PUCCH and the DMRS associated with the PUCCH mapped to the first frequency unit are mapped may be 3. In the second PUCCH format in the case that frequency hopping is applied, the total number of OFDM symbols to which the PUCCH and the DMRS associated with the PUCCH mapped to the second frequency unit are mapped may be 4. In the second PUCCH format to which frequency hopping is applied, the OFDM symbols to which the PUCCH is mapped may be the 1st, 3rd, 4th, and 7th OFDM symbols within the slot. In the second PUCCH format to which frequency hopping is applied, the OFDM symbols to which the DMRS associated with the PUCCH is mapped may be the 2nd, 5th, and 6th OFDM symbols within the slot.

In FIG. 5(b), the number N_{PUCCH, 1} of OFDM symbols to which the PUCCH included in the first frequency unit is mapped is 2. The number N_{PUCCH, 2} of OFDM symbols to which the PUCCH included in the second frequency unit is mapped is 2. The number N_{DMRS, 1} of OFDM symbols to which the DMRS included in the first frequency unit is mapped is 1. The number N_{DMRS, 2} of OFDM symbols to which the DMRS included in the second frequency unit is mapped is 2. The number N_{PUCCH_DMRS, 1} of OFDM symbols to which the PUCCH and the DMRS included in the first frequency unit are mapped is 3. The number N_{PUCCH_DMRS, 2} of OFDM symbols to which the PUCCH and the DMRS included in the second frequency unit are mapped is 4.

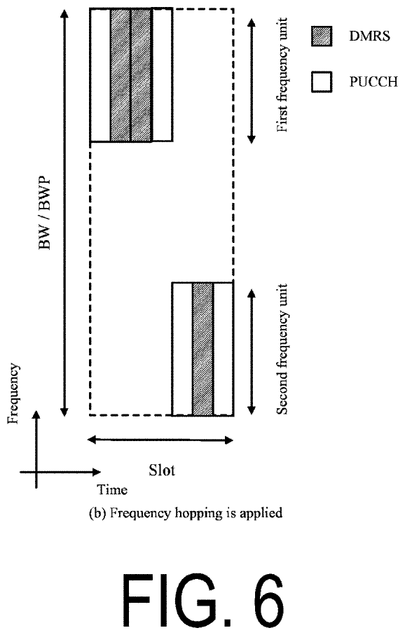

Mapping of the PUCCH and the DMRS associated with the PUCCH illustrated in FIG. 5(b) may be mapping for a slot at the first half of the subframe (or an even-numbered slot). FIG. 6 is a diagram illustrating a mapping example of the PUCCH and the DMRS associated with the PUCCH for a slot at the latter half of the subframe (or an odd-numbered slot), in the second PUCCH format to which frequency hopping is applied according to one aspect of the present embodiment. In the second PUCCH format in the case that frequency hopping is applied, the total number of OFDM symbols to which the PUCCH and the DMRS associated with the PUCCH mapped to the first frequency unit are mapped may be 4. In the second PUCCH format in the case that frequency hopping is applied, the total number of OFDM symbols to which the PUCCH and the DMRS associated with the PUCCH mapped to the second frequency unit are mapped may be 3. In the second PUCCH format to which frequency hopping is applied, the OFDM symbols to which the PUCCH is mapped may be the 1st, 4th, 5th, and 7th OFDM symbols within the slot. In the second PUCCH format to which frequency hopping is applied, the OFDM symbols to which the DMRS associated with the PUCCH is mapped may be the 2nd, 3rd, and 6th OFDM symbols within the slot.

In FIG. 6, the number N_{PUCCH, 1} of OFDM symbols to which the PUCCH included in the first frequency unit is mapped is 2. The number N_{PUCCH, 2} of OFDM symbols to which the PUCCH included in the second frequency unit is mapped is 2. The number N_{DMRS, 1} of OFDM symbols to which the DMRS included in the first frequency unit is mapped is 2. The number N_{DMRS, 2} of OFDM symbols to which the DMRS included in the second frequency unit is mapped is 1. The number N_{PUCCH_DMRS, 1} of OFDM symbols to which the PUCCH and the DMRS included in the first frequency unit are mapped is 4. The number N_{PUCCH_DMRS, 2} of OFDM symbols to which the PUCCH and the DMRS included in the second frequency unit are mapped is 3.

In the second PUCCH format to which frequency hopping is applied, a mapping pattern of the PUCCH may be given based on at least an index of the slot to which the PUCCH is mapped. The mapping pattern of the PUCCH may include at least the number of OFDM symbols including the PUCCH and/or the DMRS associated with the PUCCH mapped to the first frequency unit. The mapping pattern of the PUCCH may include at least the number of OFDM symbols including the PUCCH and/or the DMRS associated with the PUCCH mapped to the second frequency unit.

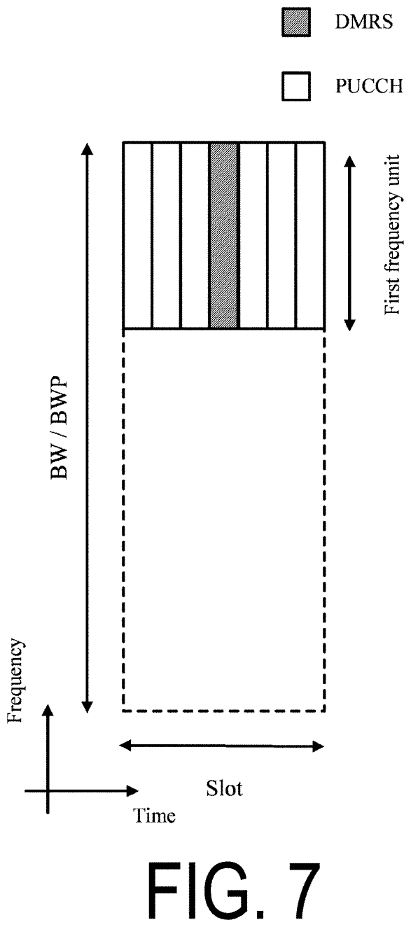

FIG. 7 is a diagram illustrating a configuration example of the third PUCCH format according to one aspect of the present embodiment. The third PUCCH format may be used at least for transmitting UCI of 3 bits or more. The UCI transmitted by using the third PUCCH format may be coded by a Reed-Muller code. In the third PUCCH format, the OFDM symbols to which the PUCCH is mapped are included in the first frequency unit. In other words, frequency hopping is not applied to the third PUCCH format. In the third PUCCH format, the first frequency unit may include one PRB. In the third PUCCH format, the first frequency unit may be the number of PRBs defined in advance.

In FIG. 7, the number NPUCCH, 1 of OFDM symbols to which the PUCCH included in the first frequency unit is mapped is 6. The number N_{PUCCH, 2} of OFDM symbols to which the PUCCH included in the second frequency unit is mapped is 0. The number N_{DMRS, 1} of OFDM symbols to which the DMRS included in the first frequency unit is mapped is 1. The number N_{DMRS, 2} of OFDM symbols to which the DMRS included in the second frequency unit is mapped is 0. The number N_{PUCCH_DMRS, 1} of OFDM symbols to which the PUCCH and the DMRS included in the first frequency unit are mapped is 7. The number N_{PUCCH_DMRS, 2} of OFDM symbols to which the PUCCH and the DMRS included in the second frequency unit are mapped is 0.

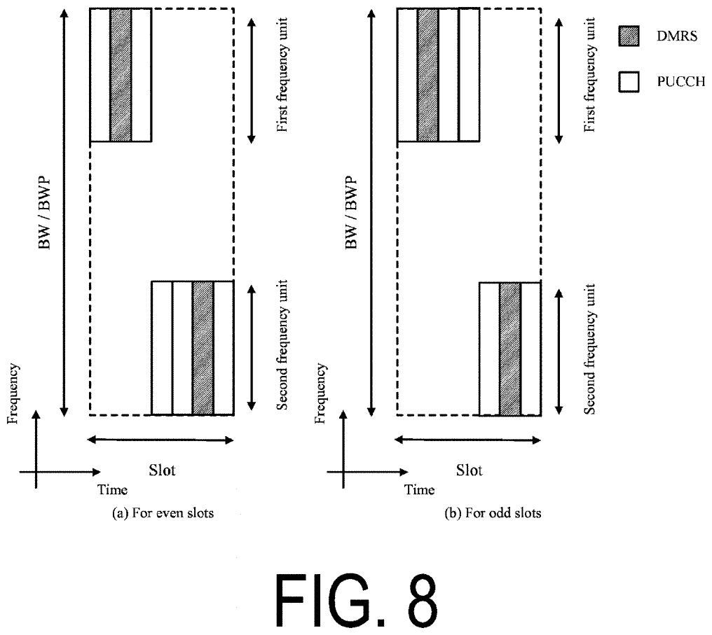

FIG. 8 is a diagram illustrating a configuration example of the fourth PUCCH format according to one aspect of the present embodiment. The fourth PUCCH format may be used for transmitting UCI of 3 bits or more. The UCI transmitted by using the fourth PUCCH format may be coded by Tail biting Convolutional Coding (TBCC) code. Frequency hopping may be applied to the fourth PUCCH format. Whether or not frequency hopping is applied to the fourth PUCCH format may be given based on at least a higher layer parameter. The number of PRBs constituting the first frequency unit and/or the second frequency unit in the fourth PUCCH format may be configured by a higher layer parameter.

FIG. 8(a) is a diagram illustrating a configuration example of the fourth PUCCH format in Even slots. In the fourth PUCCH format in even slots, the total number of OFDM symbols to which the PUCCH and the DMRS associated with the PUCCH mapped to the first frequency unit are mapped may be 3. In the fourth PUCCH format in even slots, the total number of OFDM symbols to which the PUCCH and the DMRS associated with the PUCCH mapped to the second frequency unit are mapped may be 4. In the fourth PUCCH format in even slots, the OFDM symbols to which the PUCCH is mapped may be the 1st, 3rd, 4th, 5th, and 7th OFDM symbols within the slot. In the fourth PUCCH format in even slots, the OFDM symbols to which the DMRS associated with the PUCCH is mapped may be the 2nd and 6th OFDM symbols within the slot.

In FIG. 8(a), the number N_{PUCCH, 1} of OFDM symbols to which the PUCCH included in the first frequency unit is mapped is 2. The number N_{PUCCH, 2} of OFDM symbols to which the PUCCH included in the second frequency unit is mapped is 3. The number N_{DMRS, 1} of OFDM symbols to which the DMRS included in the first frequency unit is mapped is 1. The number N_{DMRS, 2} of OFDM symbols to which the DMRS included in the second frequency unit is mapped is 1. The number N_{PUCCH_DMRS, 1} of OFDM symbols to which the PUCCH and the DMRS included in the first frequency unit are mapped is 3. The number N_{PUCCH_DMRS, 2} of OFDM symbols to which the PUCCH and the DMRS included in the second frequency unit are mapped is 4.

FIG. 8(b) is a diagram illustrating a configuration example of the fourth PUCCH format in odd slots. In the fourth PUCCH format in odd slots, the total number of OFDM symbols to which the PUCCH and the DMRS associated with the PUCCH mapped to the first frequency unit are mapped may be 4. In the fourth PUCCH format in odd slots, the total number of OFDM symbols to which the PUCCH and the DMRS associated with the PUCCH mapped to the second frequency unit are mapped may be 3. In the fourth PUCCH format in odd slots, the OFDM symbols to which the PUCCH is mapped may be the 1st, 3rd, 4th, 5th, and 7th OFDM symbols within the slot. In the fourth PUCCH format in even slots, the OFDM symbols to which the DMRS associated with the PUCCH is mapped may be the 2nd and 6th OFDM symbols within the slot.

In FIG. 8(b), the number N_{PUCCH, 1} of OFDM symbols to which the PUCCH included in the first frequency unit is mapped is 3. The number N_{PUCCH, 2} of OFDM symbols to which the PUCCH included in the second frequency unit is mapped is 2. The number N_{DMRS, 1} of OFDM symbols to which the DMRS included in the first frequency unit is mapped is 1. The number N_{DMRS, 2} of OFDM symbols to which the DMRS included in the second frequency unit is mapped is 1. The number N_{PUCCH_DMRS, 1} of OFDM symbols to which the PUCCH and the DMRS included in the first frequency unit are mapped is 4. The number N_{PUCCH_DMRS, 2} of OFDM symbols to which the PUCCH and the DMRS included in the second frequency unit are mapped is 3.

The fifth PUCCH format may be used to transmit the HARQ-ACK and/or the SR of up to 2 bits. The fifth PUCCH format is a PUCCH format used to transmit UCI through selection of a sequence. For the fifth PUCCH format, a set of PUCCH sequences is defined. The set of PUCCH sequences includes one or more PUCCH sequences. Each of the PUCCH sequences is identified based on at least an index and/or a cyclic shift used for identifying a sequence.

In the fifth PUCCH format, the number of OFDM symbols to which the PUCCH is mapped may be 1. In the fifth PUCCH format, the number of OFDM symbols to which the PUCCH is mapped may be 2. In the fifth PUCCH format, the number of OFDM symbols to which the PUCCH is mapped may be 3. In the fifth PUCCH format, the scheduling unit may include at least a part or all of 1, 2, and 3.

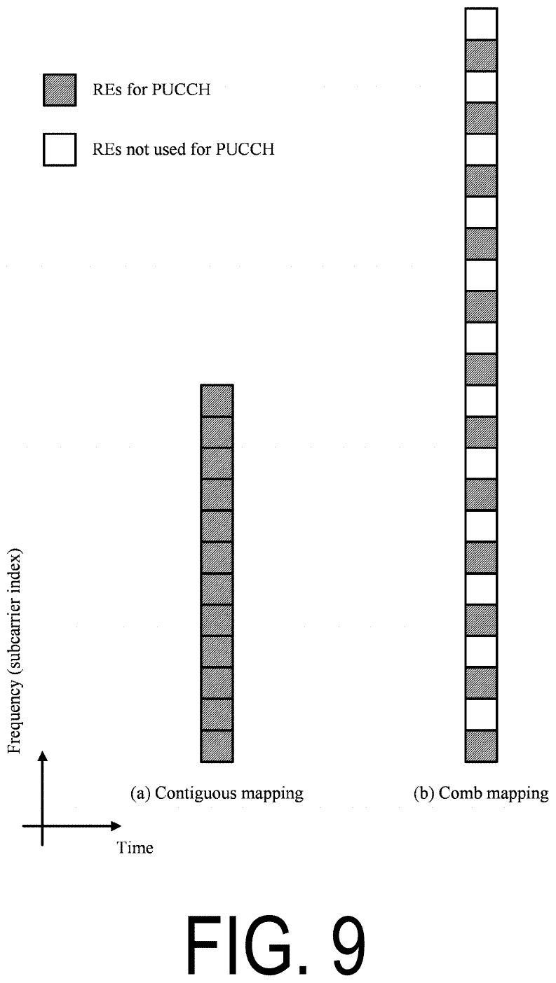

FIG. 9 is a diagram illustrating a configuration example of the fifth PUCCH format in a case that the number of OFDM symbols to which the PUCCH is mapped is 1 according to one aspect of the present embodiment. FIG. 9(a) illustrates an example of Contiguous mapping of the PUCCH. FIG. 9(b) illustrates an example of Comb mapping of the PUCCH. Whether mapping of the fifth PUCCH format in the case that the number of OFDM symbols to which the PUCCH is mapped is 1 is contiguous mapping or comb mapping may be given based on at least a higher layer parameter.

Whether or not frequency hopping is applied to the fifth PUCCH format in a case that the number of OFDM symbols to which the PUCCH is mapped is 2 may be given based on at least a higher layer parameter.

The sixth PUCCH format may be used at least for transmitting UCI of 3 bits or more. In the sixth PUCCH format, the PUCCH and the DMRS associated with the PUCCH are frequency-multiplexed.

In the sixth PUCCH format, the number of OFDM symbols to which the PUCCH is mapped may be 1. In the sixth PUCCH format, the number of OFDM symbols to which the PUCCH is mapped may be 2.

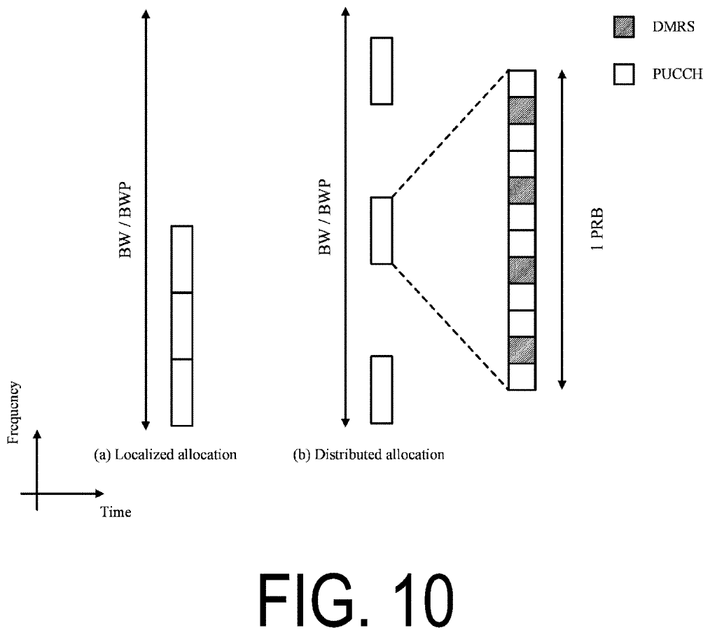

FIG. 10 is a diagram illustrating a configuration example of the sixth PUCCH format in a case that the number of OFDM symbols to which the PUCCH is mapped is 1 according to one aspect of the present embodiment. In FIG. 10, each of the blocks corresponds to one OFDM symbol of one PRB, and the blocks include eight resource elements to which the PUCCH is mapped and four resource elements to which the DMRS associated with the PUCCH is mapped.

FIG. 10(a) is a diagram illustrating an example of localized resource allocation (Localized allocation) of the block. FIG. 10(b) is a diagram illustrating an example of distributed resource allocation (Distributed allocation) of the block. Whether localized resource allocation is applied or distributed resource allocation is applied to the sixth PUCCH format may be given based on at least a higher layer parameter. The number N_{PRB} of PRBs allocated for the sixth PUCCH format may be given based on at least a higher layer parameter. The number N_{PRB} of PRBs allocated for the sixth PUCCH format may be given by a value defined in advance.

Whether or not frequency hopping is applied to the sixth PUCCH format in a case that the number of OFDM symbols to which the PUCCH is mapped is 2 may be given based on at least a higher layer parameter.

The seventh PUCCH format is used to transmit the HARQ-ACK and/or the SR of up to 2 bits. The seventh PUCCH format includes at least four OFDM symbols. In the seventh PUCCH format, the PUCCH and the DMRS associated with the PUCCH may be alternately mapped in the time domain.

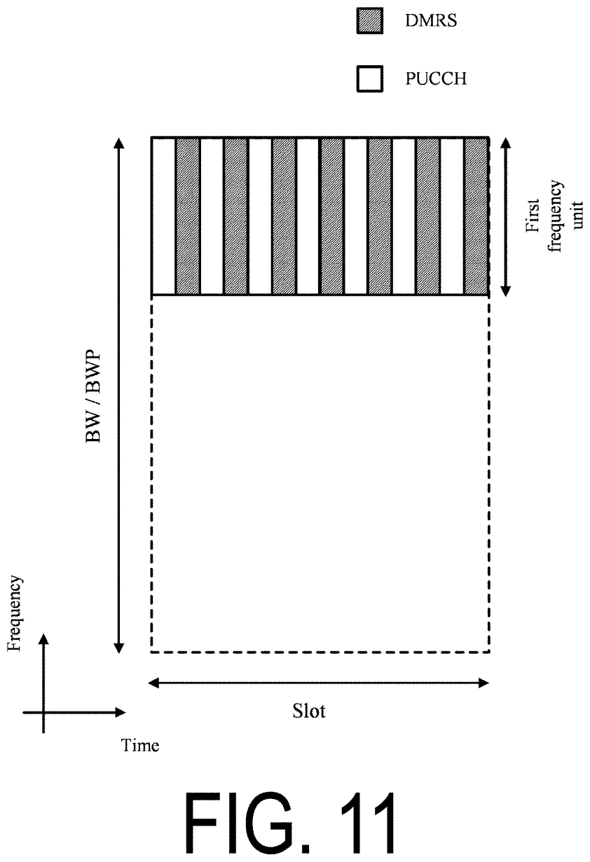

FIG. 11 is a diagram illustrating a configuration example of the seventh PUCCH format in a case that frequency hopping is not applied according to one aspect of the present embodiment. In FIG. 11, the number of OFDM symbols included in a slot is 14. In the seventh PUCCH format, the OFDM symbols to which the PUCCH is mapped may include at least a part or all of the 1st, 3rd, 5th, 7th, 9th, 11th, and 13th OFDM symbols within the slot. In the seventh PUCCH format, the OFDM symbols to which the DMRS associated with the PUCCH is mapped may include at least a part or all of the 2nd, 4th, 6th, 8th, 10th, 12th, and 14th OFDM symbols within the slot.

In the seventh PUCCH format, the OFDM symbols to which the PUCCH is mapped may include at least a part or all of the 2nd, 4th, 6th, 8th, 10th, 12th, and 14th OFDM symbols. In the seventh PUCCH format, the OFDM symbols to which the DMRS associated with the PUCCH is mapped may include at least a part or all of the 1st, 3rd, 5th, 7th, 9th, 11th, and 13th OFDM symbols within the slot. In the seventh PUCCH format, the PUCCH may be mapped to odd-numbered OFDM symbols. In the seventh PUCCH format, the DMRS associated with the PUCCH may be mapped to even-numbered OFDM symbols.

In FIG. 11, the number N_{PUCCH, 1} of OFDM symbols to which the PUCCH included in the first frequency unit is mapped is 7. The number N_{PUCCH, 2} of OFDM symbols to which the PUCCH included in the second frequency unit is mapped is 0. The number N_{DMRS, 1} of OFDM symbols to which the DMRS included in the first frequency unit is mapped is 7. The number N_{DMRS, 2} of OFDM symbols to which the DMRS included in the second frequency unit is mapped is 0. The number N_{PUCCH_DMRS, 1} of OFDM symbols to which the PUCCH and the DMRS included in the first frequency unit are mapped is 14. The number N_{PUCCH_DMRS, 2} of OFDM symbols to which the PUCCH and the DMRS included in the second frequency unit are mapped is 0.

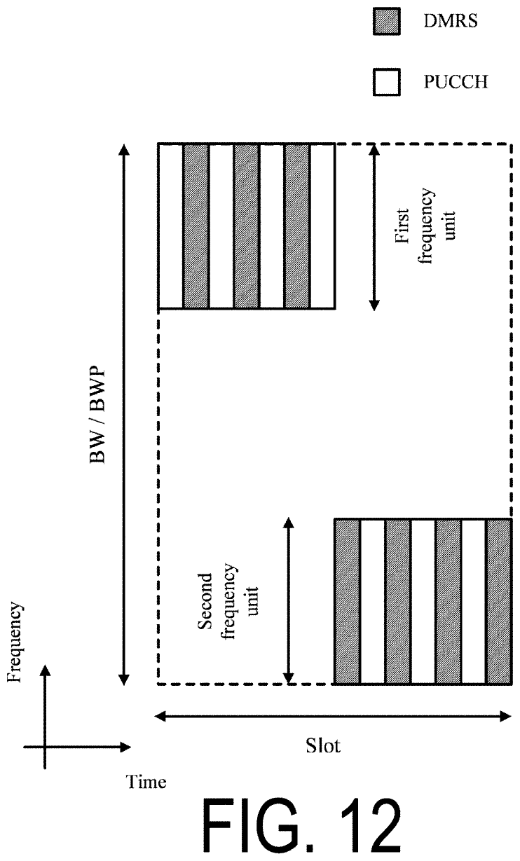

FIG. 12 is a diagram illustrating a configuration example of the seventh PUCCH format in a case that frequency hopping is applied according to one aspect of the present embodiment. In FIG. 12, the number of OFDM symbols included in a slot is 14. Numbers of the OFDM symbols to which the PUCCH is mapped in the case that frequency hopping is applied may be the same as numbers of the OFDM symbols to which the PUCCH is mapped in the case that frequency hopping is not applied. Numbers of the OFDM symbols to which the DMRS associated with the PUCCH is mapped in the case that frequency hopping is applied may be the same as numbers of the OFDM symbols to which the DMRS associated with the PUCCH is mapped in the case that frequency hopping is not applied.

In FIG. 12, the number N_{PUCCH, 1} of OFDM symbols to which the PUCCH included in the first frequency unit is mapped is 4. The number N_{PUCCH, 2} of OFDM symbols to which the PUCCH included in the second frequency unit is mapped is 3. The number N_{DMRS, 1} of OFDM symbols to which the DMRS included in the first frequency unit is mapped is 3. The number N_{DMRS, 2} of OFDM symbols to which the DMRS included in the second frequency unit is mapped is 4. The number N_{PUCCH_DMRS, 1} of OFDM symbols to which the PUCCH and the DMRS included in the first frequency unit are mapped is 7. The number N_{PUCCH_DMRS, 2} of OFDM symbols to which the PUCCH and the DMRS included in the second frequency unit are mapped is 7.

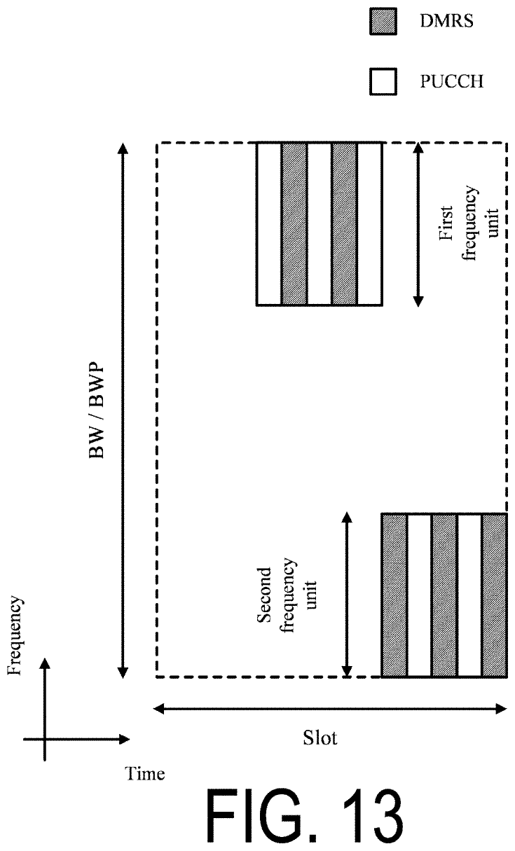

FIG. 13 is a diagram illustrating a configuration example of the seventh PUCCH format in a case that frequency hopping is applied according to one aspect of the present embodiment. In FIG. 13, the number of OFDM symbols included in a slot is 14. In FIG. 13, the total number of OFDM symbols to which the PUCCH and the DMRS associated with the PUCCH are mapped is 10. In a case that the total number of OFDM symbols to which the PUCCH and the DMRS associated with the PUCCH are mapped is less than the number of OFDM symbols included in the slot, the OFDM symbols to which the PUCCH is mapped may be given by a subset of OFDM symbols to which the PUCCH is mapped in a case that the total number of OFDM symbols to which the PUCCH and the DMRS associated with the PUCCH are mapped is equal to the number of OFDM symbols included in the slot.

In FIG. 13, the number N_{PUCCH, 1} of OFDM symbols to which the PUCCH included in the first frequency unit is mapped is 3. The number N_{PUCCH, 2} of OFDM symbols to which the PUCCH included in the second frequency unit is mapped is 2. The number N_{DMRS, 1} of OFDM symbols to which the DMRS included in the first frequency unit is mapped is 2. The number N_{DMRS, 2} of OFDM symbols to which the DMRS included in the second frequency unit is mapped is 3. The number N_{PUCCH_DMRS, 1} of OFDM symbols to which the PUCCH and the DMRS included in the first frequency unit are mapped is 5. The number N_{PUCCH_DMRS, 2} of OFDM symbols to which the PUCCH and the DMRS included in the second frequency unit are mapped is 5.

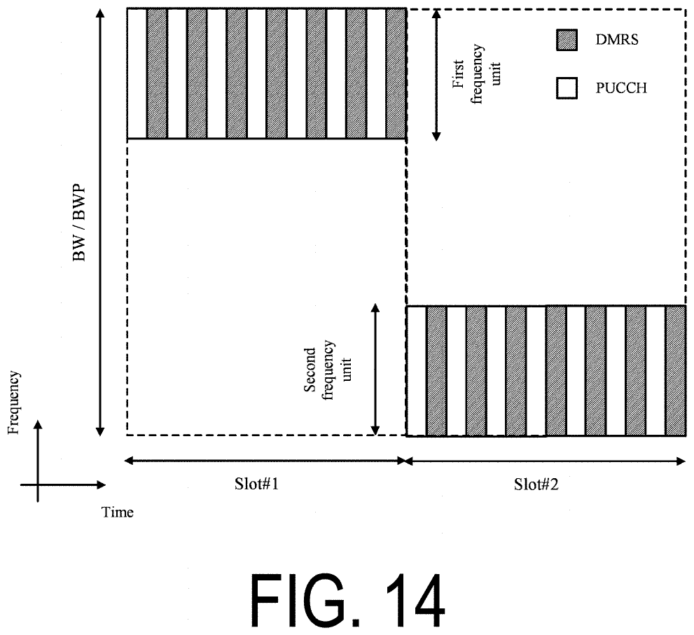

FIG. 14 is a diagram illustrating a configuration example of the seventh PUCCH format in a case that frequency hopping is applied according to one aspect of the present embodiment. In FIG. 14, the number of OFDM symbols included in a slot is 14. The PUCCH may be mapped to multiple slots. The OFDM symbols to which the PUCCH of slot #1 is mapped may be included in the first frequency unit, and the OFDM symbols to which the PUCCH of slot #2 is mapped may be included in the second frequency unit. Such frequency hopping that the OFDM symbols to which the PUCCH of a first slot is mapped are included in the first frequency unit and the OFDM symbols to which the PUCCH of a second slot is mapped are included in the second frequency unit as described above is also referred to as inter-slot hopping. The first PUCCH format is a PUCCH format to which inter-slot hopping is applied. In contrast, such frequency hopping that all of the OFDM symbols to which the PUCCH is mapped are included in one slot is also referred to as intra-slot hopping. Intra-slot hopping may be applied to the second PUCCH format to the eighth PUCCH format.

In FIG. 14, the number N_{PUCCH, 1} of OFDM symbols to which the PUCCH included in the first frequency unit is mapped is 7. The number N_{PUCCH, 2} of OFDM symbols to which the PUCCH included in the second frequency unit is mapped is 7. The number N_{DMRS, 1} of OFDM symbols to which the DMRS included in the first frequency unit is mapped is 7. The number N_{DMRS, 2} of OFDM symbols to which the DMRS included in the second frequency unit is mapped is 7. The number N_{PUCCH_DMRS, 1} of OFDM symbols to which the PUCCH and the DMRS included in the first frequency unit are mapped is 14. The number N_{PUCCH_DMRS, 2} of OFDM symbols to which the PUCCH and the DMRS included in the second frequency unit are mapped is 14.

In the seventh PUCCH format, the total number of OFDM symbols to which the PUCCH and the DMRS associated with the PUCCH are mapped may be given based on at least a higher layer parameter and/or DCI. The higher layer parameter may include a configuration related to a slot format. The configuration related to a slot format may indicate at least a DL/UL configuration of the slot. The DCI may be transmitted on a Group common PDCCH. The DCI may include a configuration associated with the slot format.

Whether or not frequency hopping is applied to the seventh PUCCH format may be given based on at least a higher layer parameter. In a case that the total number of OFDM symbols to which the PUCCH and the DMRS associated with the PUCCH are mapped is less than a prescribed value, whether or not frequency hopping is applied to the seventh PUCCH format may be given based on at least a higher layer parameter. In a case that the total number of OFDM symbols to which the PUCCH and the DMRS associated with the PUCCH are mapped is equal to or greater than the prescribed value, frequency hopping may be invariably applied to the seventh PUCCH format.

In the case that the total number of OFDM symbols to which the PUCCH and the DMRS associated with the PUCCH are mapped is less than the prescribed value, frequency hopping may not be invariably applied to the seventh PUCCH format. In the case that the total number of OFDM symbols to which the PUCCH and the DMRS associated with the PUCCH are mapped is equal to or greater than the prescribed value, whether or not frequency hopping is applied to the seventh PUCCH format may be given based on at least a higher layer parameter.

The eighth PUCCH format may be used for transmitting at least UCI of 3 bits or more.

Whether or not frequency hopping is applied to the eighth PUCCH format may be given based on at least a higher layer parameter. In a case that the total number of OFDM symbols to which the PUCCH and the DMRS associated with the PUCCH are mapped is less than a prescribed value, whether or not frequency hopping is applied to the eighth PUCCH format may be given based on at least a higher layer parameter. In a case that the total number of OFDM symbols to which the PUCCH and the DMRS associated with the PUCCH are mapped is equal to or greater than the prescribed value, frequency hopping may be invariably applied to the eighth PUCCH format.

In the case that the total number of OFDM symbols to which the PUCCH and the DMRS associated with the PUCCH are mapped is less than the prescribed value, frequency hopping may not be invariably applied to the eighth PUCCH format. In the case that the total number of OFDM symbols to which the PUCCH and the DMRS associated with the PUCCH are mapped is equal to or greater than the prescribed value, whether or not frequency hopping is applied to the eighth PUCCH format may be given based on at least a higher layer parameter.

Uplink transmit power control will be described below.

For serving cell c, transmit power P_{PUCCH}(i) of the PUCCH in slot i may be given based on following Equation (1). In a case that the PUCCH is mapped to one subframe (for example, in a case that the first PUCCH format is used), slot i may be substituted by subframe i. Each element included in Equation (1) is represented in decibel form.

$${P}_{PUCCH} ( i ) = min \{ {P}_{max , c} ( i ) , {P}_{0 \_ PUCCH} + \text{?} + h ( {n}_{CSI} , {n}_{HARQ} , {n}_{SR} ) + 10 \text{?} ( \text{?} ( i ) ) + \text{?} ( i ) + \text{?} ( F ) + \text{?} ( F ) + g ( i ) + \text{?} \} \\ \text{?} \text{indicates text missing or illegible when filed} \qquad Equation 1$$

In other words, for serving cell c, the transmit power P_{PUCCH}(i) of the PUCCH in slot i may be given based on at least a part or all of Element A to Element J.

Element A: Maximum transmit power P_{MAX, c} configured in slot i of serving cell c

Element B: P0_PUCCH given based on at least a higher layer parameter

Element C: Power correction value PL_{c} based on an estimated value of path loss

Element D: Power offset parameter h(n_{CSI}, n_{HARQ}, n_{SR}) associated with the number of bits of UCI transmitted on the PUCCH

Element E: Parameter M_{PUCCH, c} indicating a bandwidth of the PUCCH

Element F: Offset value Δ_{TF, c}(i) according to a modulation scheme/coding rate/resource use efficiency or the like, Element G: Δ_{F_PUCCH}(F)

Element H: ATXD(FTXD)

Element I: g(i)

Element J: Parameter Δₓ

Here, Element J may be included in at least a part of Element A to Element I.

P_{MAX, c} is maximum transmit power configured in slot i of serving cell c. P_{MAX, c} may be equal to P_{CMAX, c}, P_{CMAX, c} may be maximum transmit power of the terminal apparatus 1 configured in slot i of serving cell c. In Dual connectivity of LTE and NR, P_{MAX, c} may be given based on at least P_{CMAX, c}×P_{NR}. P_{NR} may be a parameter used to reduce the maximum transmit power. P_{NR} may be a parameter used to secure transmit power for LTE.

P_{0_PUCCH} is a power offset value given based on at least higher layer signaling.

PLₑ may be an estimated value of downlink Path loss in serving cell c. The estimated value of path loss may be given based on at least an SS/PBCH block and/or a CSI-RS.

h(n_{CSI}, n_{HARQ}, n_{SR}) is a power offset parameter associated with the number of bits of UCI transmitted on the PUCCH. h(n_{CSI}, n_{HARQ}, n_{SR}) is hereinafter also referred to as huci. Although h_{UCI} may be given by various methods depending on a PUCCH format, huci may be given regardless of whether frequency hopping is applied to the PUCCH format.

In the first PUCCH format, h_{UCI}=0. In a case that multiple serving cells are configured for the terminal apparatus 1 and channel selection is configured for the first PUCCH format, h_{UCI}=(n_{HARQ}−1)/2. n_{CSI} is the number of bits of CSI included in the PUCCH to be transmitted. nHARQ is the number of bits of a HARQ-ACK included in the PUCCH to be transmitted. n_{RI} is the number of bits of an RI included in the PUCCH to be transmitted.

M_{PUCCH, c} is a parameter indicating a bandwidth of the PUCCH, and may be represented by the number of resource blocks. In the first PUCCH format, M_{PUCCH, c} is 1. At least in the sixth PUCCH format, the bandwidth of the PUCCH may be given based on at least a higher layer parameter. In a case that frequency hopping is applied to the PUCCH format, the bandwidth of the PUCCH may be a bandwidth of the PUCCH mapped in the first frequency unit. In a case that frequency hopping is applied to the PUCCH format, the bandwidth of the PUCCH may be a bandwidth of the PUCCH mapped in the second frequency unit.

In a case that mapping of the PUCCH format is comb mapping, M_{PUCCH, c} may be given based on the total number of subcarriers to which the PUCCH and/or the DMRS associated with the PUCCH is mapped. For example, in FIG. 9(b), the total number of subcarriers to which the PUCCH is mapped is 12, and therefore M_{PUCCH, c} may be 1. In a case that comb mapping is applied to the PUCCH format, M_{PUCCH, c} need not be used to determine the transmit power of the PUCCH.

Δ_{TF, c}(i) represents an offset value according to a modulation scheme/coding rate/resource use efficiency or the like. The terminal apparatus 1 calculates Δ_{TF, c}(i), based on the number of bits of UCI transmitted on the PUCCH and the number of resource elements for PUCCH transmission, for example.

Δ_{F_PUCCH}(F) is given by a higher layer parameter. F is a value used to identify a PUCCH format. In other words, Δ_{F_PUCCH}(F) is given based on at least a PUCCH format. Although Δ_{F_PUCCH}(F) is given based on at least a PUCCH format, Δ_{F_PUCCH}(F) may be given regardless of whether frequency hopping is applied to the PUCCH format.

Δ_{TxD}(F_{TxD}) is given by a higher layer parameter. F_{TxD} is a value used to identify a PUCCH format. In a case that transmit diversity for the PUCCH is configured, Δ_{TxD}(F_{TxD}) is given by a higher layer parameter. In a case that transmit diversity for the PUCCH is not configured, Δ_{TxD}(F_{TxD}) is 0. In the case that transmit diversity for the PUCCH is configured, Δ_{TxD}(F_{TxD}) is a value configured for each PUCCH format by a higher layer parameter.

The terminal apparatus 1 may set a value of g(i), based on Equation (2).

g(i)=g(i−1)+δ_{PUCCH}(i−K_{PUCCH}) Equation 2

Here, PUCCH is a correction value, and is referred to as a TPC command. In other words, δ_{PUCCH}(i−K_{PUCCH}) represents a value accumulated on g(i−1). Further, δ_{PUCCH}(i−K_{PUCCH}) may be indicated based on a value set in a field of a TPC command for the PUCCH that is received in a certain slot(i−K_{PUCCH}) and is included in a downlink grant for a certain cell and DCI format 3/3A for the PUCCH. K_{PUCCH} may be a value defined in advance.

For example, a value to which a field (information field of 2 bits) of the TPC command for the PUCCH included in a downlink grant and DCI format 3 for the PUCCH is set is mapped to an accumulated correction value{−1, 0, 1, 3}. For example, a value to which a field (information field of 1 bit) of the TPC command for the PUCCH included in DCI format 3A for the PUCCH is set is mapped to an accumulated correction value{−1, 1}.

The parameter Δₓ is given based on at least a part or all of Element 1 to Element 9 below.

Element 1: Whether or not frequency hopping is applied to a PUCCH format

Element 2: Whether or not distributed resource allocation is applied to a PUCCH format

Element 3: Whether or not comb mapping is applied to a PUCCH format

Element 4: Number N_{PUCCH} of OFDM symbols to which the PUCCH is mapped

Element 5: Number N_{DMRS} of the OFDM symbols to which the DMRS associated with the PUCCH is mapped

Element 6: Total number N_{PUCCH_DMRS} of OFDM symbols to which the PUCCH and the DMRS associated with the PUCCH are mapped

Element 7: N_{diff_PUCCH}=N_{PUCCH, 1}−N_{PUCCH, 2}, representing a difference between the number N_{PUCCH, 1} of OFDM symbols included in the first frequency unit out of the OFDM symbols to which the PUCCH included in the first frequency unit is mapped and the number N_{PUCCH, 2} of OFDM symbols to which the PUCCH included in the second frequency unit is mapped

Element 8: N_{diff_DMRS}=N_{DMRS, 1}−N_{DMRS, 2}, representing a difference between the number N_{DMRS, 1} of OFDM symbols to which the association with the DMRS included in the first frequency unit is mapped and the number N_{DMRS, 2} of OFDM symbols to which the DMRS included in the second frequency unit is mapped, Element 9: N_{diff_PUCCH_DMRS}=N_{PUCCH_DMRS, 1}−N_{PUCCH_DMRS, 2}, representing a difference between the number N_{PUCCH_DMRS, 1} of OFDM symbols to which the PUCCH and the DMRS included in the first frequency unit are mapped and the number N_{PUCCH_DMRS, 2} of OFDM symbols to which the PUCCH included in the second frequency unit is mapped

In Elements 7 and 8 and Element 9, the DMRS may include at least a DMRS associated with the PUCCH.

The parameter Δₓ may be a 1st value in a case that PUCCH format X is transmitted with frequency hopping being applied. The 1st value may be 0, or a value smaller than 0. The 1st value may be selected from among a set of values 0 and smaller than 0, based on a higher layer parameter. The parameter Δₓ may be a prescribed value (for example, 0) in a case that PUCCH format X is transmitted without frequency hopping being applied. The prescribed value may be a value larger than the 1st value, or may be the same value as the 1st value.

The parameter Δₓ may be a 2nd value in a case that PUCCH format Y is transmitted with frequency hopping being applied. The 2nd value may be 0, or a value smaller than 0. The 2nd value may be selected from among a set of values 0 and smaller than 0, based on a higher layer parameter. The parameter Δₓ may be a prescribed value (for example, 0) in a case that PUCCH format Y is transmitted without frequency hopping being applied. The prescribed value may be a value larger than the 2nd value, or may be the same value as the 2nd value.

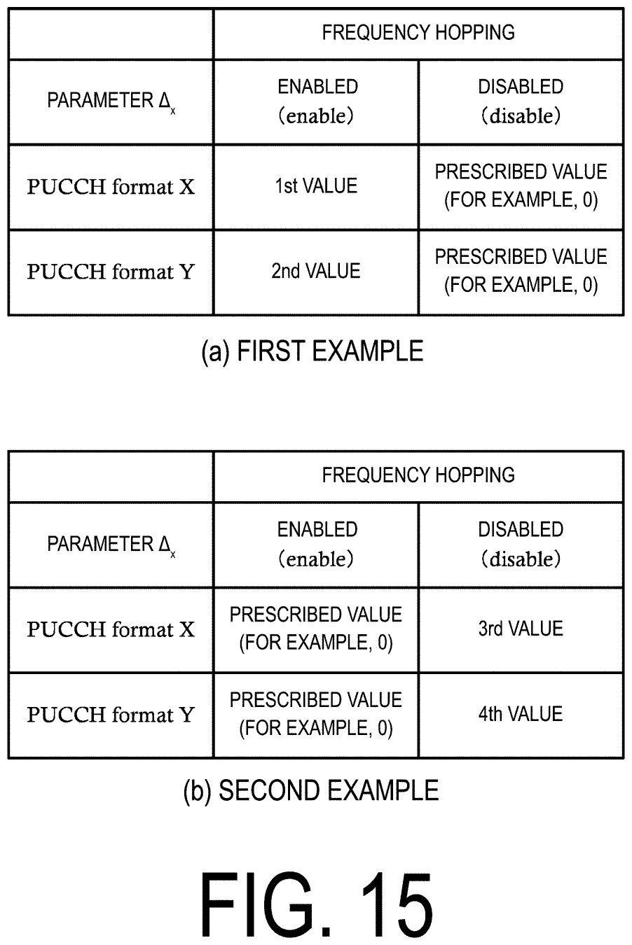

FIG. 15 is a diagram illustrating a configuration example of the parameter Δₓ according to one aspect of the present embodiment. FIG. 15(a) is a diagram illustrating a configuration example of the parameter Δₓ. As illustrated in FIG. 15(a), the parameter Δₓ may be the 1st value in a case that frequency hopping is enabled for transmission of PUCCH format X. The parameter Δₓ may be the prescribed value in a case that frequency hopping is disabled for transmission of PUCCH format X. The parameter Δₓ may be the 2nd value in a case that frequency hopping is enabled for transmission of PUCCH format Y. The parameter Δₓ may be the prescribed value in a case that frequency hopping is disabled for transmission of PUCCH format Y. A case that frequency hopping is enabled for transmission of a PUCCH format indicates that a PUCCH format is transmitted with frequency hopping being applied. A case that frequency hopping is disabled for transmission of a PUCCH format indicates that a PUCCH format is transmitted without frequency hopping being applied.

Here, which of the PUCCH formats is transmitted may be given based on at least a 1st higher layer parameter. Whether frequency hopping is enabled or disabled for transmission of a PUCCH format may be given based on at least a 2nd higher layer parameter. The 1st value for the parameter Δₓ may be given based on a 3rd higher layer parameter. The 2nd value for the parameter Δₓ may be given based on at least a 4th higher layer parameter.

The parameter Δₓ may be a 3rd value in a case that PUCCH format X is transmitted without frequency hopping being applied. The 3rd value may be 0, or a value larger than 0. The 3rd value may be selected from among a set of values 0 and larger than 0, based on a higher layer parameter. The parameter Δₓ may be a prescribed value (for example, 0) in a case that PUCCH format X is transmitted with frequency hopping being applied. The prescribed value may be a value smaller than the 3rd value, or may be the same value as the 3rd value.

The parameter Δₓ may be a 4th value in a case that PUCCH format Y is transmitted without frequency hopping being applied. The 4th value may be 0, or a value larger than 0. The 4th value may be selected from among a set of values 0 and larger than 0, based on a higher layer parameter. The parameter Δₓ may be a prescribed value (for example, 0) in a case that PUCCH format Y is transmitted with frequency hopping being applied. The prescribed value may be a value smaller than the 2nd value, or may be the same value as the 4th value.

FIG. 15(b) is a diagram illustrating a configuration example of the parameter Δₓ. As illustrated in FIG. 15(b), the parameter Δₓ may be the prescribed value in a case that frequency hopping is enabled for transmission of PUCCH format X. The parameter Δₓ may be the 3rd value in a case that frequency hopping is disabled for transmission of PUCCH format X. The parameter Δₓ may be the prescribed value in a case that frequency hopping is enabled for transmission of PUCCH format Y. The parameter Δₓ may be the 4th value in a case that frequency hopping is disabled for transmission of PUCCH format Y.

Here, which of the PUCCH formats is transmitted may be given based on at least a 5th higher layer parameter. Further, whether frequency hopping is enabled or disabled for transmission of a PUCCH format may be given based on at least a 6th higher layer parameter. The 3rd value for the parameter Δₓ may be given based on at least a 7th higher layer parameter. The 4th value for the parameter Δₓ may be given based on at least an 8th higher layer parameter.

The parameter Δₓ may be a 5th value in a case that PUCCH format X is transmitted with distributed resource allocation being applied. The 5th value may be 0, or a value smaller than 0. The 5th value may be selected from among a set of values 0 and smaller than 0. The parameter Δₓ may be a prescribed value (for example, 0) in a case that PUCCH format X is transmitted with localized resource allocation being applied. The prescribed value may be a value larger than the 5th value, or may be the same value as the 5th value.

The parameter Δₓ may be a 6th value in a case that PUCCH format Y is transmitted with distributed resource allocation being applied. The 6th value may be 0, or a value smaller than 0. The 6th value may be selected from among a set of values 0 and smaller than 0. The parameter Δₓ may be a prescribed value (for example, 0) in a case that PUCCH format Y is transmitted with localized resource allocation being applied. The prescribed value may be a value larger than the 6th value, or may be the same value as the 6th value.

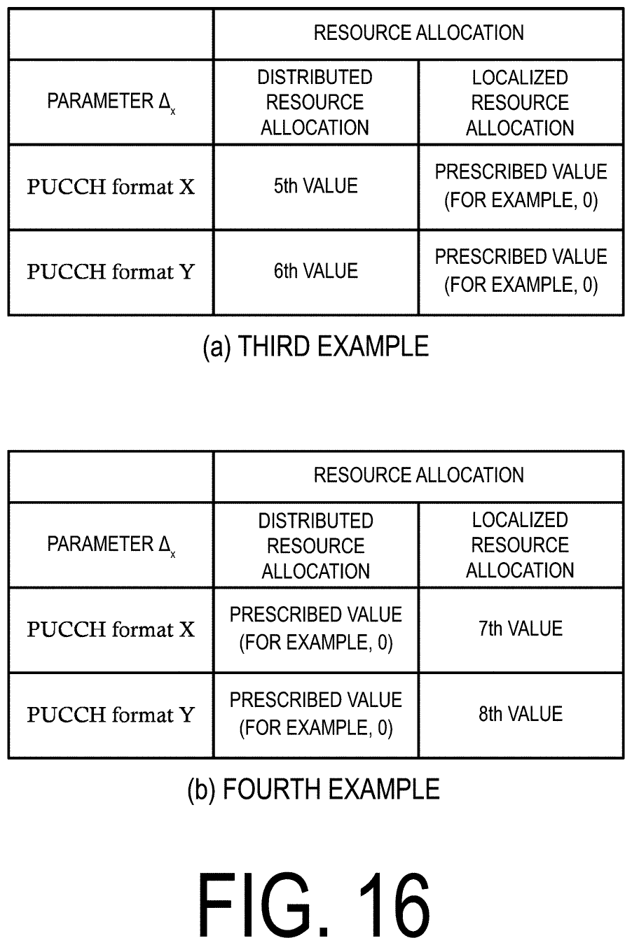

FIG. 16 is a diagram illustrating a configuration example of the parameter Δₓ according to one aspect of the present embodiment. FIG. 16(a) is a diagram illustrating a configuration example of the parameter Δₓ. As illustrated in FIG. 16(a), the parameter Δₓ may be the 5th value in a case that distributed resource allocation is configured for transmission of PUCCH format X. The parameter Δₓ may be the prescribed value in a case that localized resource allocation is configured for transmission of PUCCH format X. The parameter Δₓ may be the 6th value in a case that distributed resource allocation is configured for transmission of PUCCH format Y. The parameter Δₓ may be the prescribed value in a case that localized resource allocation is configured for transmission of PUCCH format Y.

Here, which of the PUCCH formats is transmitted may be given based on at least a 9th higher layer parameter. Further, whether localized resource allocation is applied or distributed resource allocation is applied to transmission of a PUCCH format may be given based on at least a 10th higher layer parameter. The 5th value for the parameter Δₓ may be given based on at least an 11th higher layer parameter. The 6th value for the parameter Δₓ may be given based on at least a 12th higher layer parameter.

The parameter Δₓ may be a 7th value in a case that PUCCH format X is transmitted with localized resource allocation being applied. The 7th value may be 0, or a value larger than 0. The 7th value may be selected from among a set of values 0 and larger than 0, based on a higher layer parameter. The parameter Δₓ may be a prescribed value (for example, 0) in a case that PUCCH format X is transmitted with distributed resource allocation being applied. The prescribed value may be a value smaller than the 7th value, or may be the same value as the 7th value.

The parameter Δₓ may be an 8th value in a case that PUCCH format Y is transmitted with localized resource allocation being applied. The 8th value may be 0, or a value larger than 0. The 8th value may be selected from among a set of values 0 and larger than 0, based on a higher layer parameter. The parameter Δₓ may be a prescribed value (for example, 0) in a case that PUCCH format Y is transmitted with frequency hopping being applied. The prescribed value may be a value smaller than the 8th value, or may be the same value as the 8th value.

FIG. 16(b) is a diagram illustrating a configuration example of the parameter Δₓ. As illustrated in FIG. 16(b), the parameter Δₓ may be the prescribed value in a case that distributed resource allocation is applied to transmission of PUCCH format X. The parameter Δₓ may be the 7th value in a case that localized resource allocation is applied to transmission of PUCCH format X. The parameter Δₓ may be the prescribed value in a case that distributed resource allocation is applied to transmission of PUCCH format Y. The parameter Δₓ may be the 8th value in a case that localized resource allocation is applied to transmission of PUCCH format Y.

Here, which of the PUCCH formats is transmitted may be given based on at least a 13th higher layer parameter. Whether localized resource allocation is applied or distributed resource allocation is applied to transmission of a PUCCH format may be given based on at least a 14th higher layer parameter. The 7th value for the parameter Δₓ may be given based on at least a 15th higher layer parameter. The 8th value may be given based on at least a 16th higher layer parameter.

The parameter Δₓ may be a 9th value in a case that PUCCH format X is transmitted with comb mapping being applied. The 9th value may be 0, or a value smaller than 0. The 9th value may be selected from among a set of values 0 and smaller than 0, based on a higher layer parameter. The parameter Δₓ may be a prescribed value (for example, 0) in a case that PUCCH format X is transmitted with contiguous mapping being applied. The prescribed value may be a value larger than the 9th value, or may be the same value as the 9th value.

The parameter Δₓ may be a 10th value in a case that PUCCH format Y is transmitted with comb mapping being applied. The 10th value may be 0, or a value smaller than 0. The 10th value may be selected from among a set of values 0 and smaller than 0, based on a higher layer parameter. The parameter Δₓ may be a prescribed value (for example, 0) in a case that PUCCH format Y is transmitted with contiguous mapping being applied. The prescribed value may be a value larger than the 10th value, or may be the same value as the 10th value.

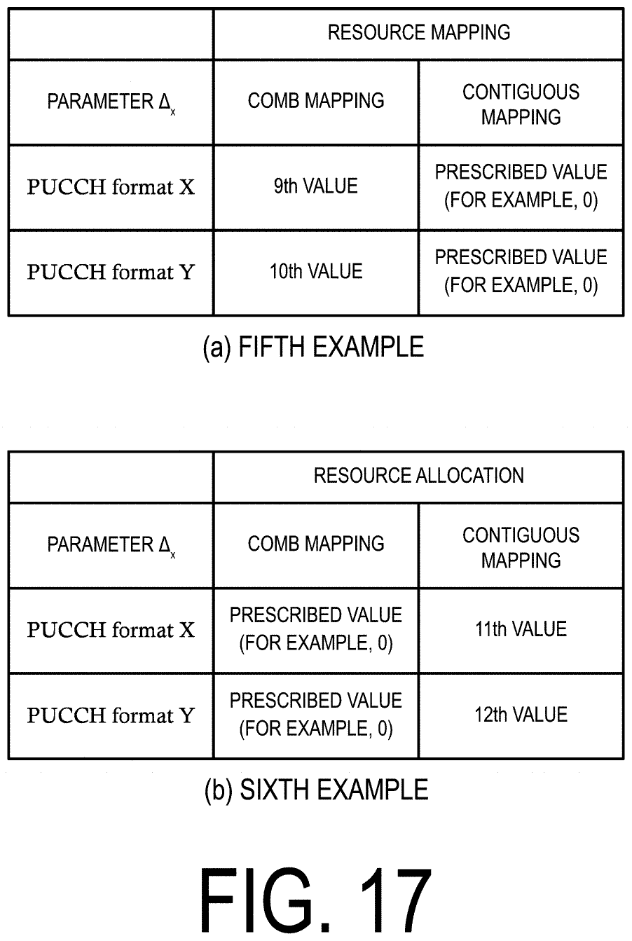

FIG. 17 is a diagram illustrating a configuration example of the parameter Δₓ according to one aspect of the present embodiment. FIG. 17(a) is a diagram illustrating a configuration example of the parameter Δₓ. As illustrated in FIG. 17(a), the parameter Δₓ may be the 9th value in a case that comb mapping is configured for transmission of PUCCH format X. The parameter Δₓ may be the prescribed value in a case that contiguous mapping is configured for transmission of PUCCH format X. The parameter Δₓ may be the 10th value in a case that comb mapping is configured for transmission of PUCCH format Y. The parameter Δₓ may be the prescribed value in a case that contiguous mapping is configured for transmission of PUCCH format Y.

Here, which of the PUCCH formats is transmitted may be given based on at least a 17th higher layer parameter. Further, whether contiguous mapping is applied or comb mapping is applied to transmission of a PUCCH format may be given based on at least an 18th higher layer parameter. The 9th value for the parameter Δₓ may be given based on at least a 19th higher layer parameter. The 10th value may be given based on at least a 20th higher layer parameter.

The parameter Δₓ may be an 11th value in a case that PUCCH format X is transmitted with contiguous mapping being applied. The 11th value may be 0, or a value larger than 0. The 11th value may be selected from among a set of values 0 and larger than 0, based on a higher layer parameter. The parameter Δₓ may be a prescribed value (for example, 0) in a case that PUCCH format X is transmitted with comb mapping being applied. The prescribed value may be a value smaller than the 11th value, or may be the same value as the 11th value.

The parameter Δₓ may be a 12th value in a case that PUCCH format Y is transmitted with contiguous mapping being applied. The 12th value may be 0, or a value larger than 0. The 11th value may be selected from among a set of values 0 and larger than 0, based on a higher layer parameter. The parameter Δₓ may be a prescribed value (for example, 0) in a case that PUCCH format Y is transmitted with frequency hopping being applied. The prescribed value may be a value smaller than the 12th value, or may be the same value as the 12th value.

FIG. 17(b) is a diagram illustrating a configuration example of the parameter Δₓ. As illustrated in FIG. 17(b), the parameter Δₓ may be the prescribed value in a case that comb mapping is applied to transmission of PUCCH format X. The parameter Δₓ may be the 11th value in a case that contiguous mapping is applied to transmission of PUCCH format X. The parameter Δₓ may be the prescribed value in a case that comb mapping is applied to transmission of PUCCH format Y. Further, parameter Ax may be the 12th value in a case that contiguous mapping is applied to transmission of PUCCH format Y.

Here, which of the PUCCH formats is transmitted may be given based on at least a 21st higher layer parameter. Further, whether contiguous mapping is applied or comb mapping is applied to transmission of a PUCCH format may be given based on at least a 22nd higher layer parameter. The 11th value for the parameter Δₓ may be given based on at least a 23rd higher layer parameter. The 12th value may be given based on at least a 24th higher layer parameter.

The parameter Δx may be given based on at least whether frequency hopping to be applied to a PUCCH format is intra-slot hopping or inter-slot hopping.

Whether or not frequency hopping is applied to a PUCCH format may be given based on at least a part or all of a type of the PUCCH format, the number of OFDM symbols included in the PUCCH format, a frequency bandwidth of a serving cell used to transmit the PUCCH format, a frequency bandwidth of a BWP used to transmit the PUCCH format, an index of a BWP used to transmit the PUCCH format, and a downlink grant at least used to trigger transmission of the PUCCH format.

Whether localized resource allocation is applied or distributed resource allocation is applied to a PUCCH format may be given based on at least a part or all of a type of the PUCCH format, the number of OFDM symbols included in the PUCCH format, a frequency bandwidth of a serving cell used to transmit the PUCCH format, a frequency bandwidth of a BWP used to transmit the PUCCH format, an index of a BWP used to transmit the PUCCH format, and a downlink grant at least used to trigger transmission of the PUCCH format.

Whether contiguous mapping is applied or comb mapping is applied to a PUCCH format may be given based on at least a part or all of a type of the PUCCH format, the number of OFDM symbols included in the PUCCH format, a frequency bandwidth of a serving cell used to transmit the PUCCH format, a frequency bandwidth of a BWP used to transmit the PUCCH format, an index of a BWP used to transmit the PUCCH format, and a downlink grant at least used to trigger transmission of the PUCCH format.

For transmission of PUCCH format X, the value of Δₓ may be given based on at least the number N_{X_DMRS} of OFDM symbols to which the DMRS is mapped. The DMRS may be a DMRS associated with the PUCCH.

In a case that frequency hopping is applied to transmission of PUCCH format X, the value of Δₓ may be given based on at least N_{X_diff_DMRS}=N_{X_DMRS, 1}−N_{X_DMRS, 2}, representing a difference between the number N_{X_DMRS, 1} of OFDM symbols to which the DMRS included in the first frequency unit is mapped and the number N_{X_DMRS, 2} of OFDM symbols to which the DMRS included in the second frequency unit is mapped. The DMRS may be a DMRS associated with the PUCCH. In the case that frequency hopping is applied to transmission of PUCCH format X, the value of Δₓ in a case that N_{X_diff_DMRS} is 0 may be different from the value of Δₓ in a case that N_{X_diff_DMRS} is not 0. The value of Δₓ may be given by a higher layer parameter individually for the value of N_{X_diff_DMRS}. The value of Δₓ may be given based on at least whether or not N_{X_diff_DMRS} is 0. N_{X_diff_DMRS} may be given based on at least the number of OFDM symbols to which the DMRS included in PUCCH format X is mapped.

For transmission of PUCCH format Y, the value of Δₓ may be given based on at least the number N_{Y_DMRS} of OFDM symbols to which the DMRS is mapped. The DMRS may be a DMRS associated with the PUCCH.

In a case that frequency hopping is applied to transmission of PUCCH format Y, the value of Δₓ may be given based on at least N_{Y_diff_DMRS}=N_{Y_DMRS, 1}−N_{Y_DMRS, 2}, representing a difference between the number N_{Y_DMRS, 1} of OFDM symbols to which the DMRS included in the first frequency unit is mapped and the number N_{Y_DMRS, 2} of OFDM symbols to which the DMRS included in the second frequency unit is mapped. The DMRS may be a DMRS associated with the PUCCH. In the case that frequency hopping is applied to transmission of PUCCH format Y, the value of Δₓ in a case that N_{Y_diff_DMRS} is 0 may be different from the value of Δₓ in a case that N_{Y_diff_DMRS} is not 0. The value of Δₓ may be given by a higher layer parameter individually for the value of N_{Y_diff_DMRS}. The value of Δₓ may be given based on at least whether or not N_{Y_diff_DMRS} is 0. N_{Y_diff_DMRS} may be given based on at least the number of OFDM symbols to which the DMRS included in PUCCH format Y is mapped.

For transmission of PUCCH format X, the value of Δₓ may be given based on at least the number N_{X_PUCCH} of OFDM symbols to which the PUCCH is mapped.

In the case that frequency hopping is applied to transmission of PUCCH format X, the value of Δₓ may be given based on at least N_{X_diff_PUCCH}=N_{X_PUCCH, 1}−N_{X_PUCCH, 2}, representing a difference between the number N_{X_PUCCH, 1} of OFDM symbols to which the PUCCH included in the first frequency unit is mapped and the number N_{X_PUCCH, 2} of OFDM symbols to which the PUCCH included in the second frequency unit is mapped. In the case that frequency hopping is applied to transmission of PUCCH format X, the value of Δₓ in a case that N_{X_diff_PUCCH} is 0 may be different from the value of Δₓ in a case that N_{X_diff_PUCCH} is not 0. The value of Δₓ may be given by a higher layer parameter individually for the value of N_{X_diff_PUCCH}. The value of Δₓ may be given based on at least whether or not N_{X_diff_PUCCH} is 0. N_{X_diff_PUCCH} may be given based on at least the number of OFDM symbols to which the PUCCH included in PUCCH format X is mapped.

For transmission of PUCCH format Y, the value of Δₓ may be given based on at least the number N_{Y_PUCCH} of OFDM symbols to which the PUCCH is mapped.

In the case that frequency hopping is applied to transmission of PUCCH format Y, the value of Δₓ may be given based on at least N_{Y_diff_PUCCH}=N_{Y_PUCCH, 1}−N_{Y_PUCCH, 2}, representing a difference between the number N_{Y_PUCCH, 1} of OFDM symbols to which the PUCCH included in the first frequency unit is mapped and the number N_{Y_PUCCH, 2} of OFDM symbols to which the PUCCH included in the second frequency unit is mapped. In the case that frequency hopping is applied to transmission of PUCCH format Y, the value of Δₓ in a case that N_{Y_diff_PUCCH} is 0 may be different from the value of Δₓ in a case that N_{Y_diff_PUCCH} is not 0. The value of Δₓ may be given by a higher layer parameter individually for the value of N_{Y_diff_PUCCH}. The value of Δₓ may be given based on at least whether or not N_{Y_diff_PUCCH} is 0. N_{Y_diff_PUCCH} may be given based on at least the number of OFDM symbols to which the PUCCH included in PUCCH format Y is mapped.

For transmission of PUCCH format X, the value of Δₓ may be given based on at least the number N_{X_PUCCH_DMRS} of OFDM symbols to which the PUCCH and the DMRS associated with the PUCCH are mapped.

In the case that frequency hopping is applied to transmission of PUCCH format X, the value of Δₓ may be given based on at least N_{X_diff_PUCCH_DMRS}=N_{X_PUCCH_DMRS, 1}−N_{X_PUCCH_DMRS, 2}, representing a difference between the number N_{X_PUCCH_DMRS, 1} of OFDM symbols to which the PUCCH and the DMRS included in the first frequency unit are mapped and the number N_{X_PUCCH_DMRS, 2} of OFDM symbols to which the PUCCH and the DMRS included in the second frequency unit are mapped. The DMRS may be a DMRS associated with the PUCCH. In the case that frequency hopping is applied to transmission of PUCCH format X, the value of Δₓ in a case that N_{X_diff_PUCCH_DMRS} is 0 may be different from the value of Δₓ in a case that N_{X_diff_PUCCH_DMRS} is not 0. The value of Δₓ may be given by a higher layer parameter individually for the value of N_{X_diff_PUCCH_DMRS}. The value of Δₓ may be given based on at least whether or not N_{X_diff_PUCCH_DMRS} is 0. N_{X_diff_PUCCH_DMRS} may be given based on at least the number of OFDM symbols to which the PUCCH and the DMRS included in PUCCH format X are mapped.

For transmission of PUCCH format Y, the value of Δₓ may be given based on at least the number N_{Y_PUCCH_DMRS} of OFDM symbols to which the PUCCH and the DMRS associated with the PUCCH are mapped.

In the case that frequency hopping is applied to transmission of PUCCH format Y, the value of Δₓ may be given based on at least N_{Y_diff_PUCCH_DMRS}=N_{Y_PUCCH_DMRS, 1}−N_{Y_PUCCH_DMRS, 2}, representing a difference between the number N_{Y_PUCCH_DMRS, 1} of OFDM symbols to which the PUCCH and the DMRS included in the first frequency unit are mapped and the number N_{Y_PUCCH_DMRS, 2} of OFDM symbols to which the PUCCH and the DMRS included in the second frequency unit are mapped. In the case that frequency hopping is applied to transmission of PUCCH format Y, the value of Δₓ in a case that N_{Y_diff_PUCCH_DMRS} is 0 may be different from the value of Δₓ in a case that N_{Y_diff_PUCCH_DMRS} is not 0. The value of Δₓ may be given by a higher layer parameter individually for the value of N_{Y_diff_PUCCH_DMRS}. The value of Δₓ may be given based on at least whether or not N_{Y_diff_PUCCH_DMRS} is 0. N_{Y_diff_PUCCH_DMRS} may be given based on at least the number of OFDM symbols to which the PUCCH and the DMRS included in PUCCH format Y are mapped.

The base station apparatus 3 and the terminal apparatus 1 exchange (transmit and/or receive) a signal in the higher layer. For example, the base station apparatus 3 and the terminal apparatus 1 may transmit and/or receive Radio Resource Control (RRC) signaling (also referred to as a Radio Resource Control (RRC) message or Radio Resource Control (RRC) information) in a Radio Resource Control (RRC) layer. Furthermore, the base station apparatus 3 and the terminal apparatus 1 may transmit and/or receive a MAC Control Element (CE) in the MAC layer. Here, the RRC signaling and/or the MAC CE is also referred to as higher layer signaling.

The PUSCH and the PDSCH are used at least to transmit the RRC signaling and/or the MAC CE. Here, the RRC signaling transmitted from the base station apparatus 3 on the PDSCH may be signaling common to multiple terminal apparatuses 1 in a serving cell. The signaling common to multiple terminal apparatuses 1 in a serving cell is also referred to as common RRC signaling. The RRC signaling transmitted from the base station apparatus 3 on the PDSCH may be signaling dedicated to a certain terminal apparatus 1 (also referred to as dedicated signaling or UE specific signaling). The signaling dedicated to the terminal apparatus 1 is also referred to as dedicated RRC signaling. A higher layer parameter specific to a serving cell may be transmitted using signaling common to multiple terminal apparatuses 1 within the serving cell, or signaling dedicated to a certain terminal apparatus 1. A UE-specific higher layer parameter may be transmitted using signaling dedicated to a certain terminal apparatus 1. The PDSCH including the dedicated RRC signaling may be scheduled on the PDCCH in the first control resource set.

The Broadcast Control CHannel (BCCH), the Common Control CHannel (CCCH), and the Dedicated Control CHannel (DCCH) are logical channels. For example, the BCCH is a higher layer channel used to transmit the MIB. Moreover, the Common Control Channel (CCCH) is a higher layer channel used to transmit information common to multiple terminal apparatuses 1. Here, the CCCH is used for the terminal apparatus 1 which is not in an RRC-connected state, for example. Moreover, the Dedicated Control Channel (DCCH) is a higher layer channel used to transmit individual control information (dedicated control information) to the terminal apparatus 1. Here, the DCCH is used for the terminal apparatus 1 which is in an RRC-connected state, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel is mapped to the PUSCH in the physical channel. The DL-SCH in the transport channel is mapped to the PDSCH in the physical channel. The BCH in the transport channel is mapped to the PBCH in the physical channel.

A configuration example of the terminal apparatus 1 according to the one aspect of the present embodiment will be described below.

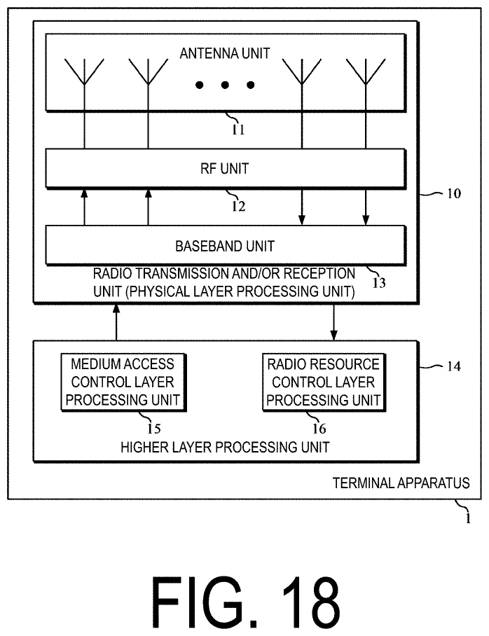

FIG. 18 is a schematic block diagram illustrating a configuration of the terminal apparatus 1 according to one aspect of the present embodiment. As illustrated, the terminal apparatus 1 includes a radio transmission and/or reception unit 10 and a higher layer processing unit 14. The radio transmission and/or reception unit 10 includes at least a part or all of an antenna unit 11, a Radio Frequency (RF) unit 12, and a baseband unit 13. The higher layer processing unit 14 includes at least a part or all of a medium access control layer processing unit 15 and a radio resource control layer processing unit 16. The radio transmission and/or reception unit 10 is also referred to as a transmitter, a receiver or a physical layer processing unit.

The higher layer processing unit 14 outputs uplink data (transport block) generated by a user operation or the like, to the radio transmission and/or reception unit 10. The higher layer processing unit 14 performs processing of a MAC layer, a Packet Data Convergence Protocol (PDCP) layer, a Radio Link Control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters, based on a higher layer signal received from the base station apparatus 3. Namely, the radio resource control layer processing unit 16 sets the various types of configuration information/parameters, based on the information for indicating the various types of configuration information/parameters received from the base station apparatus 3. Each of the parameters may be a higher layer parameter.

The radio transmission and/or reception unit 10 performs processing of the physical layer, such as modulation, demodulation, coding, decoding, and the like. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data and generating a baseband signal (performing conversion to a time-continuous signal), and transmits the generated signal to the base station apparatus 3.

The RF unit 12 converts (down-converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the digital signal resulting from the conversion, performs Fast Fourier Transform (FFT) of the signal from which the CP has been removed, and extracts a signal in the frequency domain.

The baseband unit 13 generates an OFDM symbol by performing Inverse Fast Fourier Transform (IFFT) of the data, adds CP to the generated OFDM symbol, generates a baseband digital signal, and converts the baseband digital signal into an analog signal. The baseband unit 13 outputs the analog signal resulting from the conversion, to the RF unit 12.

The RF unit 12 removes unnecessary frequency components from the analog signal input from the baseband unit 13 using a low-pass filter, up-converts the analog signal into a signal of a carrier frequency, and transmits the up-converted signal via the antenna unit 11. Furthermore, the RF unit 12 amplifies power. Furthermore, the RF unit 12 may have a function of controlling transmit power. The RF unit 12 is also referred to as a transmit power control unit.

A configuration example of the base station apparatus 3 according to one aspect of the present embodiment will be described below.

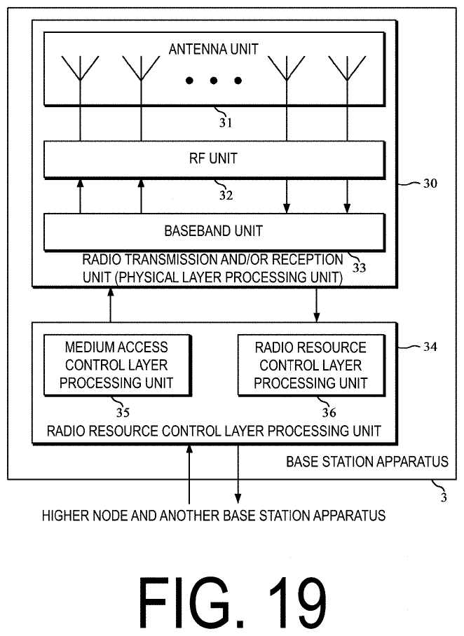

FIG. 19 is a schematic block diagram illustrating a configuration of the base station apparatus 3 according to one aspect of the present embodiment. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver or a physical layer processing unit.

The higher layer processing unit 34 performs processing of a MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) allocated on PDSCH, system information, an RRC message, a MAC CE, and the like, and performs output to the radio transmission and/or reception unit 30. Furthermore, the radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. That is, the radio resource control layer processing unit 36 transmits/broadcasts information for indicating various types of configuration information/parameters.

The functionality of the radio transmission and/or reception unit 30 is similar to the functionality of the radio transmission and/or reception unit 10, and hence description thereof is omitted.

Each of the units having the reference signs 10 to 16 included in the terminal apparatus 1 may be configured as a circuit. Each of the units having the reference signs 30 to 36 included in the base station apparatus 3 may be configured as a circuit.

Various aspects of apparatuses according to one aspect of the present embodiment will be described below.

(1) To accomplish the object described above, aspects of the present invention are contrived to provide the following measures. Specifically, a first aspect of the present invention is a terminal apparatus including: a receiver configured to receive first RRC signaling; a controller configured to determine transmit power of a PUCCH; and a transmitter configured to transmit uplink control information on the PUCCH, wherein the first RRC signaling includes information indicating whether or not frequency hopping is applied to the PUCCH, the transmit power of the PUCCH is given based on at least a parameter 4, and the parameter Δₓ is given based on at least whether or not frequency hopping is applied to the PUCCH.

(2) Further, in the first aspect of the present invention, the parameter Δₓ is further given based on at least PUCCH format F of the PUCCH, and the PUCCH format F includes at least a first PUCCH format used to transmit the uplink control information of 2 bits or less, and a second PUCCH format used to transmit the uplink control information of 3 bits or more.

(3) Further, in the first aspect of the present invention, in a case that frequency hopping is applied to the PUCCH, the parameter Δₓ is given based on at least second RRC signaling, and in a case that frequency hopping is not applied to the PUCCH, the parameter Δₓ is 0.

(4) Further, in the first aspect of the present invention, in a case that frequency hopping is applied to the PUCCH, the parameter Δₓ is 0, and in a case that frequency hopping is not applied to the PUCCH, the parameter Δₓ is given based on at least second RRC signaling.

(5) Further, a second aspect of the present invention is a base station apparatus including: a transmitter configured to transmit first RRC signaling; and a receiver configured to receive uplink control information transmitted on a PUCCH, wherein the first RRC signaling includes information indicating whether or not frequency hopping is applied to the PUCCH, the transmit power of the PUCCH is given based on at least a parameter Δₓ and the parameter Δₓ is given based on at least whether or not frequency hopping is applied to the PUCCH.

(6) Further, in the second aspect of the present invention, the parameter Δₓ is further given based on at least PUCCH format F of the PUCCH, and the PUCCH format F includes at least a first PUCCH format used to transmit the uplink control information of 2 bits or less, and a second PUCCH format used to transmit the uplink control information of 3 bits or more.

(7) Further, in the second aspect of the present invention, in a case that frequency hopping is applied to the PUCCH, the parameter Δₓ is given based on at least second RRC signaling, and in a case that frequency hopping is not applied to the PUCCH, the parameter Δₓ is 0.

(8) Further, in the second aspect of the present invention, in a case that frequency hopping is applied to the PUCCH, the parameter Δₓ is 0, and in a case that frequency hopping is not applied to the PUCCH, the parameter Δₓ is given based on at least second RRC signaling.

A program running on the base station apparatus 3 and the terminal apparatus 1 according to the present invention may be a program that controls a Central Processing Unit (CPU) and the like (program that causes a computer to perform its functions), so that the program implements the functions of the above-described embodiment according to the present invention. The information handled in these apparatuses is temporarily stored in a Random Access Memory (RAM) while being processed. Thereafter, the information is stored in various types of Read Only Memory (ROM) such as a Flash ROM and a Hard Disk Drive (HDD), and when necessary, is read by the CPU to be modified or rewritten.

Note that the terminal apparatus 1 and the base station apparatus 3 according to the above-described embodiment may be partially achieved by a computer. In that case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station apparatus 3 according to the above-described embodiment may be achieved as an aggregation (apparatus group) including multiple apparatuses. Each of the apparatuses constituting such an apparatus group may include some or all portions of each function or each functional block of the base station apparatus 3 according to the above-described embodiment. The apparatus group is required to have each general function or each functional block of the base station apparatus 3. Furthermore, the terminal apparatus 1 according to the above-described embodiment can also communicate with the base station apparatus as the aggregation.

Furthermore, the base station apparatus 3 according to the above-described embodiment may serve as an Evolved Universal Terrestrial Radio Access Network (EUTRAN). Furthermore, the base station apparatus 3 according to the above-described embodiment may have some or all portions of the functions of a node higher than an eNodeB.

Furthermore, some or all portions of each of the terminal apparatus 1 and the base station apparatus 3 according to the above-described embodiment may be typically achieved as an LSI which is an integrated circuit or may be achieved as a chip set. The functional blocks of each of the terminal apparatus 1 and the base station apparatus 3 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case where with advances in semiconductor technology, a circuit integration technology with which an LSI is replaced appears, it is also possible to use an integrated circuit based on the technology.

Furthermore, according to the above-described embodiment, the terminal apparatus has been described as an example of a communication apparatus, but the present invention is not limited to such a terminal apparatus, and is applicable to a terminal apparatus or a communication apparatus of a fixed-type or a stationary-type electronic apparatus installed indoors or outdoors, for example, such as an Audio-Video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### CROSS REFERENCE TO RELATED APPLICATIONS

This application claims the benefit of priority to JP 2017-186511 filed on Sep. 27, 2017, the entire contents of which are incorporated herein by reference.

### REFERENCE SIGNS LIST

1 (1A, 1B, 1C) Terminal apparatus
3 Base station apparatus
10, 30 Radio transmission and/or reception unit
11, 31 Antenna unit
12, 32 RF unit
13, 33 Baseband unit
14, 34 Higher layer processing unit
15, 35 Medium access control layer processing unit
16, 36 Radio resource control layer processing unit

1. A terminal apparatus comprising:
a receiver configured to receive first RRC signaling;
a controller configured to determine transmit power of a PUCCH; and
a transmitter configured to transmit uplink control information on the PUCCH, wherein
the first RRC signaling includes information indicating whether or not frequency hopping is applied to the PUCCH,
the transmit power of the PUCCH is given based on at least a parameter Δₓ, and
the parameter Δₓ is given based on at least whether or not the frequency hopping is applied to the PUCCH.

2. The terminal apparatus according to claim 1, wherein
the parameter Δₓ is further given based on at least PUCCH format F of the PUCCH, and
the PUCCH format F includes at least a first PUCCH format used to transmit the uplink control information of two bits or less, and a second PUCCH format used to transmit the uplink control information of three bits or more.

3. The terminal apparatus according to claim 1, wherein
in a case that the frequency hopping is applied to the PUCCH, the parameter Δₓ is given based on at least second RRC signaling, and
in a case that the frequency hopping is not applied to the PUCCH, the parameter Δₓ is zero.

4. The terminal apparatus according to claim 1, wherein
in a case that the frequency hopping is applied to the PUCCH, the parameter Δₓ is zero, and
in a case that the frequency hopping is not applied to the PUCCH, the parameter Δₓ is given based on at least second RRC signaling.

5. A base station apparatus comprising:
a transmitter configured to transmit first RRC signaling; and
a receiver configured to receive uplink control information transmitted on a PUCCH, wherein
the first RRC signaling includes information indicating whether or not frequency hopping is applied to the PUCCH,
transmit power of the PUCCH is given based on at least a parameter Δₓ, and
the parameter Δₓ is given based on at least whether or not the frequency hopping is applied to the PUCCH.

6. The base station apparatus according to claim 5, wherein
the parameter Δₓ is further given based on at least PUCCH format F of the PUCCH, and
the PUCCH format F includes at least a first PUCCH format used to transmit the uplink control information of two bits or less, and a second PUCCH format used to transmit the uplink control information of three bits or more.

7. The base station apparatus according to claim 5, wherein
in a case that the frequency hopping is applied to the PUCCH, the parameter Δₓ is given based on at least second RRC signaling, and
in a case that the frequency hopping is not applied to the PUCCH, the parameter Δₓ is zero.

8. The base station apparatus according to claim 5, wherein
in a case that the frequency hopping is applied to the PUCCH, the parameter Δₓ is zero, and
in a case that the frequency hopping is not applied to the PUCCH, the parameter Δₓ is given based on at least second RRC signaling.

9. A communication method used for a terminal apparatus, the communication method comprising the steps of:
receiving first RRC signaling;
determining transmit power of a PUCCH; and
transmitting uplink control information on the PUCCH, wherein
the first RRC signaling includes information indicating whether or not frequency hopping is applied to the PUCCH,
the transmit power of the PUCCH is given based on at least a parameter Δₓ, and
the parameter Δₓ is given based on at least whether or not the frequency hopping is applied to the PUCCH.

10. A communication method used for a base station apparatus, the communication method comprising the steps of:
transmitting first RRC signaling; and
receiving uplink control information transmitted on a PUCCH, wherein
the first RRC signaling includes information indicating whether or not frequency hopping is applied to the PUCCH,
transmit power of the PUCCH is given based on at least a parameter Δₓ, and
the parameter Δₓ is given based on at least whether or not the frequency hopping is applied to the PUCCH.
